(19) United States
(12) Patent Application Publication
(10) Pub. No.: US 2016/0283571 A1
(43) Pub. Date: Sep. 29, 2016

(54) APPARATUS, SYSTEM AND METHOD FOR EFFICIENT AND LOW-DELAY SYNCHRONIZATION OF GRAPH-SHAPED DATA STRUCTURES

(71) Applicant: Fraunhofer-Gesellschaft zur Foerderung der angewandten Forschung e.V., Munich (DE)

(72) Inventors: Gabriel GATZSCHE, Martinroda (DE); Tobias GEHLHAAR, Erfurt (DE); Thomas SPORER, Fuerth (DE); Maximilian HELLER, Ilmenau (DE); Mario SEIDENECK, Teistungen (DE)

(21) Appl. No.: 15/173,458

(22) Filed: Jun. 3, 2016

Related U.S. Application Data
(63) Continuation of application No. PCT/EP2014/076273, filed on Dec. 2, 2014.

(30) Foreign Application Priority Data
Dec. 5, 2013 (DE) 102013225058.4

(51) Int. Cl. G06F 17/30

(52) U.S. Cl. CPC G06F 17/30575; G06F 17/30958

(57) ABSTRACT

An apparatus includes a data model, the data model including three or more nodes, one or more of the three or more nodes of the data model having an ID assigned to it, each of the one or more nodes being unambiguously distinguishable from the other nodes of the data model by its ID, at least two of the nodes of the data model each having one or more attributes, each of the attributes being able to adopt a value stored within the data model, each node of the at least two nodes having a path indication assigned to it, the path indication having the respective node to which the path indication is assigned and at least one further of the three or more nodes of the data model, and the path indication of each node of the at least two nodes differing from the ID of the respective node.

### CROSS-REFERENCE TO RELATED APPLICATIONS

This application is a continuation of copending International Application No. PCT/EP2014/076273, filed Dec. 2, 2014, which claims priority from German Application No. DE 10 2013 225 058.4, filed Dec. 5, 2013, which are each incorporated herein in its entirety by this reference thereto.

The patent application relates to low-delay synchronization and, specifically, to an apparatus, a system and a method for efficient low-delay synchronization of graph-shaped, e.g., tree-shaped, data structures.

### BACKGROUND OF THE INVENTION

A large number of software applications internally use a graph-shaped data structure, e.g., a data structure organized in the shape of a tree. In such a data structure organized in the shape of a tree, the state of the application can be held in such a data structure. If parts of the data structure change, the application will react to this and will change the screen display, for example, or will control a connected peripheral device. The underlying design pattern is referred to as MVC (model view controller).

If one wishes to perform such an application, the state of which is held in such a graph-shaped, e.g., tree-shaped, data structure, on several devices simultaneously, for example in order to allow several users to collaboratively (jointly/cooperatively) work with the application, or if a user wants to distribute different displays of the application to different terminal devices, e.g., a tablet PC and a mobile phone, for the purpose of improved operability, the following will have to happen:

On the one hand, communication protocols for synchronizing the application simultaneously running on different terminal devices may be provided and implemented in a manner involving a large amount of effort. Said implementation typically is expensive and time-consuming and, thus, is also prone to errors.

On the other hand, said protocols are expected to be fast and efficient. No noticeable delay is allowed to occur between a user input on a first device and the updating of the application on a further device. Especially for controlling audio systems, synchronization may not take longer than few milliseconds.

Conventional technology has already known apparatus with which one can simultaneously control a system by using several mobile devices, e.g., Mackie-Control or diverse iPad controls for mixing desks.

Currently, communication of different clients (clients, client applications) of an application is effected with the aid of databases as a rule. Via a database protocol, states are set within a database which are in turn transmitted to the different clients. There are two approaches to this:

The first approach is a so-called key-value approach, see the Redis database, for example. A key has a data set stored therewith. The data set can be quickly accessed via the key. The advantage of this approach is a high level of performance. However, the development of complex applications on the basis of the key-value approach is incalculable and thus expensive and prone to errors.

The second approach is a so-called document-oriented approach, see CouchDb, MongoDb, for example. The data is structured in the shape of a graph and can be accessed via an address path. This approach enables achieving well-structured data and, thus, applications that are easily to handle. Applications therefore are developed are developed fast and in a straightforward manner. The disadvantage is that accesses to the data are expensive. For control data that changes with high frequency and has a low latency, such an approach is not very suitable, however.

However, it would be desirable if concepts were provided which on the one hand implement a high level of performance in the low-delay synchronization and in data updating and which on the other hand implement a high degree of intuitiveness during a data access.

### SUMMARY

According to an embodiment, an apparatus may have: a data model, said data model having three or more nodes, one or more of the three or more nodes of the data model having an ID assigned to it, each of said one or more nodes being unambiguously distinguishable from the other nodes of the data model by its ID, at least two of the nodes of the data model each having one or more attributes, each of said attributes being able to adopt a value stored within the data model, each node of said at least two nodes having a path indication assigned to it, the path indication having the respective node to which said path indication is assigned and at least one further of the three or more nodes of the data model, and the path indication of each node of said at least two nodes differing from the ID of the respective node, a controller having a writing function for each attribute of each one of the three or more nodes of the data model which haves attributes, and the value of the attribute being changeable by means of the writing function, and a synchronizer, the synchronizer being configured to receive an update notification designating one of the nodes of the data model, said update notification further designating an attribute of said node, and the update notification indicating how the value of this attribute is to be updated, the update notification designating the node by means of the ID of the node, and the controller being configured to update the value of this attribute of this node as a function of the update notification by means of the writing function of this attribute, the apparatus further having an interface configured to receive information about changes of the data model which add one or more attributes to one of the nodes of the data model, the apparatus being configured to generate a writing function for each of said added one or more attributes by means of code generation, the value of the attribute being changeable by means of this writing function, this writing function being configured to inform the synchronizer and/or a view when the value of the attribute changes.

According to another embodiment, a server may be an apparatus as claimed in claim 1 and may be configured to receive (a) registration(s) from one or more clients, the server being configured to transmit information about the data model to the one or more clients upon their registrations, said information about the data model having the values of the attributes of all of the nodes or of two or more of the nodes of the data model which have attributes, and the information about the data model further indicating, for each node of the data model or for the at least two nodes of the data model, which of the nodes of the data model immediately follow said node and/or which nodes of the data model immediately precede said node.

According to another embodiment, a client may be an apparatus which may have: a data model, said data model having three or more nodes, one or more of the three or more nodes of the data model having an ID assigned to it, each of said one or more nodes being unambiguously distinguishable from the other nodes of the data model by its ID, at least two of the nodes of the data model each having one or more attributes, each of said attributes being able to adopt a value stored within the data model, each node of said at least two nodes having a path indication assigned to it, the path indication having the respective node to which said path indication is assigned and at least one further of the three or more nodes of the data model, and the path indication of each node of said at least two nodes differing from the ID of the respective node, a controller having a writing function for each attribute of each one of the three or more nodes of the data model which haves attributes, and the value of the attribute being changeable by means of the writing function, and a synchronizer, the synchronizer being configured to receive an update notification designating one of the nodes of the data model, said update notification further designating an attribute of said node, and the update notification indicating how the value of this attribute is to be updated, the update notification designating the node by means of the ID of the node, and the controller being configured to update the value of this attribute of this node as a function of the update notification by means of the writing function of this attribute, the apparatus further having an interface configured to receive information about changes of the data model which add one or more attributes to one of the nodes of the data model, the apparatus being configured to generate a writing function for each of said added one or more attributes by means of code generation, the value of the attribute being changeable by means of this writing function, this writing function being configured to inform the synchronizer and/or a view when the value of the attribute changes, the client being configured to register with a server as claimed in claim 12, the client being configured to receive, upon registration with the server, information about the data model of the server, said information about the data model of the server having the values of the attributes of all of the nodes or of two or more of the nodes of the data model of the server which have attributes, and the information about the data model of the server further indicating, for each node of the data model or for the two or more nodes of the data model of the server, which of the nodes of the data model of the server immediately follow said node and/or which nodes of the data model of the server immediately precede said node, and the client being configured to update its data model as a function of the information about the data model of the server.

According to another embodiment, a system may have: a server, the server being an apparatus as claimed in claim 1, the server being configured to receive (a) registration(s) from one or more clients, the server being configured to transmit information about the data model to the one or more clients upon their registrations, said information about the data model having the values of the attributes of all of the nodes or of two or more of the nodes of the data model which have attributes, and the information about the data model further indicating, for each node of the data model or for the at least two nodes of the data model, which of the nodes of the data model immediately follow said node and/or which nodes of the data model immediately precede said node, and a client as claimed in claim 19, the client being configured to send an update notification to the server, the synchronizer of the server being configured to receive the update notification which designates one of the nodes of the data model of the server, which further designates an attribute of said node and which indicates how the value of this attribute is to be updated, and the controller of the server being configured to update the value of this attribute of this node as a function of the update notification if the update notification designates the ID of the node.

According to another embodiment, a method may have the steps of: receiving an update notification designating a node of a data model by means of an ID of the node, said update notification further designating an attribute of said node, and said update notification indicating how a value of this attribute is to be updated, said data model having three or more nodes, one or more of the three or more nodes of the data model having an ID assigned to it, each of said one or more nodes being unambiguously distinguishable from the other nodes of the data model by its ID, at least two of the nodes of the data model each having one or more attributes, each of said attributes being able to adopt a value stored within the data model, each node of said at least two nodes having a path indication assigned to it, the path indication having the respective node to which said path indication is assigned and at least one further of the three or more nodes of the data model, and the path indication of each node of said at least two nodes differing from the ID of the respective node, and updating the value of the attribute designated in the update notification by means of the writing function of this attribute as a function of the update notification, receiving, by means of an interface, information about changes of the data model which add one or more attributes to one of the nodes of the data model, and generating a writing function for each of said added one or more attributes by means of code generation, the value of the attribute being changeable by means of this writing function, this writing function being configured to inform the synchronizer and/or a view when the value of the attribute changes.

According to another embodiment, a non-transitory digital storage medium may have a computer program stored thereon to perform the method which may have the steps of: receiving an update notification designating a node of a data model by means of an ID of the node, said update notification further designating an attribute of said node, and said update notification indicating how a value of this attribute is to be updated, said data model having three or more nodes, one or more of the three or more nodes of the data model having an ID assigned to it, each of said one or more nodes being unambiguously distinguishable from the other nodes of the data model by its ID, at least two of the nodes of the data model each having one or more attributes, each of said attributes being able to adopt a value stored within the data model, each node of said at least two nodes having a path indication assigned to it, the path indication having the respective node to which said path indication is assigned and at least one further of the three or more nodes of the data model, and the path indication of each node of said at least two nodes differing from the ID of the respective node, and updating the value of the attribute designated in the update notification by means of the writing function of this attribute as a function of the update notification, receiving, by means of an interface, information about changes of the data model which add one or more attributes to one of the nodes of the data model, and generating a writing function for each of said added one or more attributes by means of code generation, the value of the attribute being changeable by means of this writing function, this writing function being configured to inform the synchronizer and/or a view when the value of the attribute changes, when said computer program is run by a computer.

An apparatus is provided. The apparatus includes a data model, the data model including three or more nodes, one or more of the three or more nodes of the data model having an ID associated with them, each of said one or more nodes being unambiguously distinguishable from the other nodes of the data model by its ID, at least two of the nodes of the data model each having one or more attributes, it being possible for each of said attributes to adopt a value which is stored within the data model, each node of said at least two nodes having a path indication assigned thereto, the path indication comprising the respective node to which said path indication is assigned and at least a further one of the three or more nodes of the data model, and the path indication of each node of said at least two nodes differing from the ID of the respective node.

In one embodiment, for example, each of the nodes of the data model may have an ID assigned to it, each of the nodes of the data model being unambiguously distinguishable from the other nodes of the data model by its ID.

Moreover, the apparatus includes a controller which includes a writing function for each attribute of each one of the three or more nodes of the data model which has attributes, and the value of the attribute being changeable by means of the writing function. Moreover, the apparatus includes a synchronizer. The synchronizer is configured to receive an update notification designating one of the nodes of the data model, said update notification moreover designating an attribute of said node, and the update notification indicating how the value of this attribute is to be updated, the update notification designating the node by means of the ID of the node. The controller is configured to update the value of this attribute of this node as a function of the update notification by means of the writing function of this attribute.

In embodiments, the writing function takes on not only setting of the value within the data model, but also takes on informing of the synchronizer and/or informing of further observers as well as further possible functions such as recording of changes over time for the purpose of later reproduction or undoing.

In accordance with embodiments, the synchronizer is configured to send update notifications.

Embodiments of the invention comprise numerous advantages as compared to conventional technology, for example a clearly easier extensibility of the synchronization protocol, fully web-based implementation of transparent synchronization for the application developer, and/or easy integration of new components. While in conventional technology, providers define merely a protocol rather than persistent data representation within the client and within the server, in accordance with embodiments persistent data representation is defined and the protocol is derived therefrom. Embodiments provide further tools.

In accordance with one embodiment, a server is provided. The server is an apparatus as was described above. Moreover, the server is configured to receive a registration (login) from one or more clients. In addition, the server is configured to transfer information about the data model to the one or more clients upon their registration, said information about the data model including the values of the attributes of all of the nodes or of two or more of the nodes of the data model which have attributes, and the information about the data model further indicating, for each node of the data model or for the at least two nodes of the data model, which one or more of the nodes of the data model immediately follow said node and/or which one or more nodes of the data model immediately precede said node.

In one embodiment, the server may be configured, for example, to transfer the IDs of two or more of the nodes of the data model of the server to the one or more clients upon their registration.

In accordance with a further embodiment, a client is provided. The server is an apparatus as was described above. Moreover, the client is configured to register with the above-described server. The client is configured to receive, upon registration with the server, information about the data model of the server, said information about the data model of the server including the values of the attributes of all of the nodes or of two or more of the nodes of the data model of the server which have attributes, and the information about the data model of the server further indicating, for each node of the data model or for the two or more nodes of the data model of the server, which of the nodes of the data model of the server immediately follow said node and/or which nodes of the data model of the server immediately precede said node. Moreover, the client is configured to update its data model as a function of the information about the data model of the server.

Furthermore, as system is provided. The system includes the above-described server and the above-described client. The client is configured to send an update notification to the server. The synchronizer of the server is configured to receive the update notification, which designates one of the nodes of the data model, which moreover designates an attribute of said node and which indicates how the value of said attribute is to be updated. The controller of the server is configured to update the value of said attribute of said node as a function of the update notification if the update notification designates the ID of the node.

Moreover, a method is provided. The method includes:
receiving an update notification designating a node of a data model by means of an ID of the node, said update notification further designating an attribute of said node, and said update notification indicating how a value of this attribute is to be updated, said data model including three or more nodes, one or more of the three or more nodes of the data model having an ID assigned to it, each of said one or more nodes being unambiguously distinguishable from the other nodes of the data model by its ID, at least two of the nodes of the data model each comprising one or more attributes, each of said attributes being able to adopt a value stored within the data model, each node of said at least two nodes having a path indication assigned to it, the path indication comprising the respective node to which said path indication is assigned and at least one further of the three or more nodes of the data model, and the path indication of each node of said at least two nodes differing from the ID of the respective node. And
updating the value of the attribute designated in the update notification by means of the writing function of this attribute as a function of the update notification.

In embodiments, the method may include, e.g., a further step or further steps, for example:
generating the IDs and/or
updates between the client and the server
matching the data models between the server and the client and/or
specifying the writing function/storing function.

Moreover, a computer program having a program code for performing the above-described method is provided.

### BRIEF DESCRIPTION OF THE DRAWINGS

Embodiments of the present invention will be detailed subsequently referring to the appended drawings, in which:

FIG. 1a shows an apparatus in accordance with one embodiment,

FIG. 1b shows the hierarchic graph structure of the data model in accordance with one embodiment,

FIG. 1c shows a system in accordance with one embodiment,

FIG. 2a shows a data model, an observer structure and a controller structure,

FIG. 2b shows a possible course of the synchronization between a client and a server,

FIG. 2c shows a practical example for installing a sonication system without using UI.FM,

FIGS. 2d to 2g show inventive application examples of low-delay synchronization in accordance with embodiments,

FIG. 3 shows a UI.FM system in accordance with advantageous embodiments,

FIGS. 4a to 4e show further inventive application examples of low-delay synchronization in accordance with embodiments,

FIGS. 5a to 5c show inventive realizations of web applications in accordance with one embodiment,

FIGS. 6a, 6b show further embodiments of the low-delay synchronization in accordance with embodiments,

FIGS. 7a to 7f show a data model and its implementation, in terms of programming, in accordance with one embodiment,

FIGS. 8a to 8g show the console inputs of programming commands and the results returned in accordance with embodiments,

FIGS. 9a to 9h show the change in a data structure by adding an attribute in accordance with one embodiment,

FIGS. 10a to 10e show how users can let themselves to be informed, in accordance with one embodiment, when a value of the data model changes, and

FIG. 11 shows an alert output upon reproduction of data recording in accordance with the reproduced data recording in accordance with an embodiment.

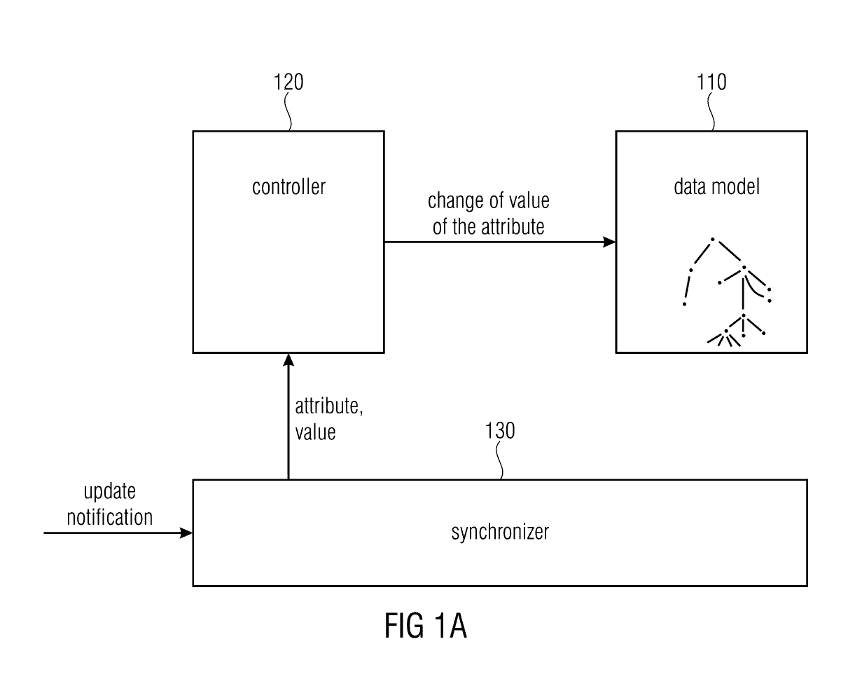

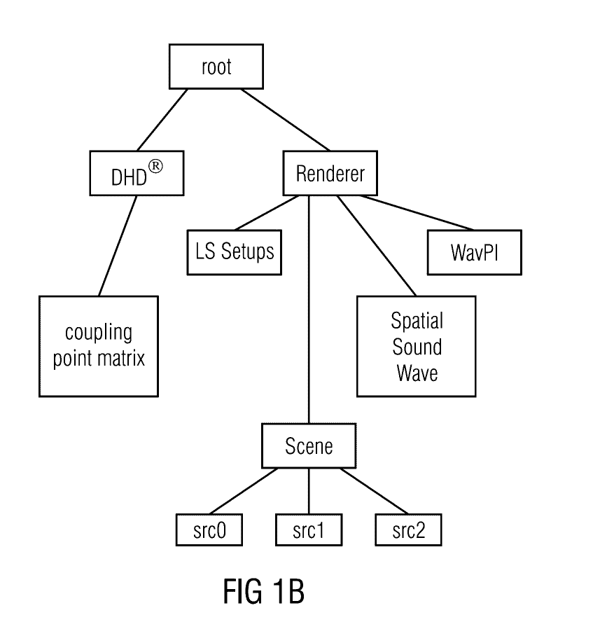

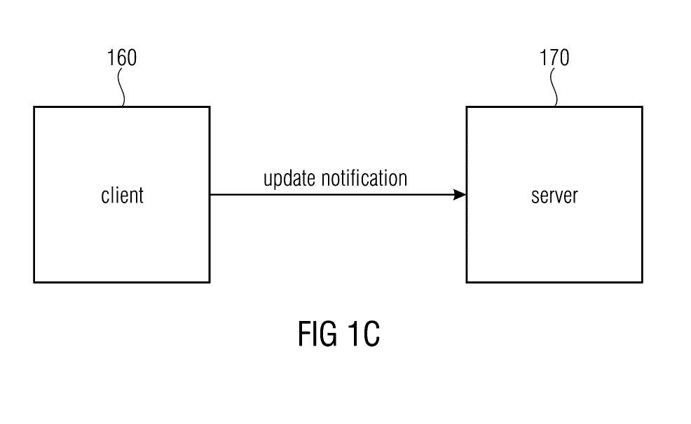

FIG. 1a shows an apparatus in accordance with an embodiment.

### DETAILED DESCRIPTION OF THE INVENTION

The apparatus includes a data model 110, said data model 110 including three or more nodes, one or more of the three or more nodes of the data model 110 having an ID assigned to it, each of said one or more nodes being unambiguously distinguishable from the other nodes of the data model 110 by its ID, at least two of the nodes of the data model 110 each comprising one or more attributes, each of said attributes being able to adopt a value stored within the data model 110, each node of said at least two nodes having a path indication assigned to it, the path indication comprising the respective node to which said path indication is assigned and at least one further of the three or more nodes of the data model 110, and the path indication of each node of said at least two nodes differing from the ID of the respective node.

In one embodiment, each of the nodes of the data model 110 may have an ID assigned to it, for example, each of the nodes of the data model being unambiguously distinguishable from the other nodes of the data model 110 by its ID.

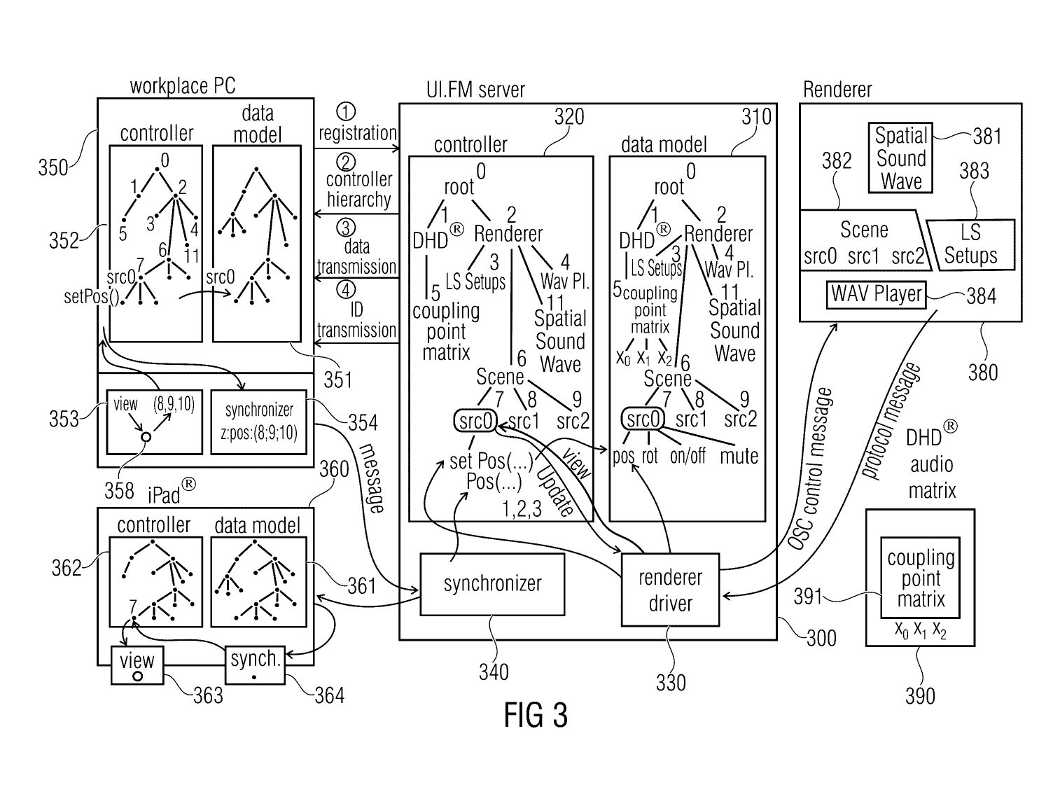

In other words, therefore, numerous ones of the nodes of the data model comprise path indications comprising more than one node. For example, if in a tree hierarchy, for example, a node “Renderer” immediately follows the node “root”, the path indication may be referred to as “root. Renderer”, for example, and said path indication thus comprises two of the nodes of the data model, namely “root” and “Renderer”. Beyond the path indication “root.Renderer”, the node “Renderer” also has an ID assigned to it which is unambiguous in the data model, for example the number “2” (see, e.g., data model 310 in FIG. 3). However, in any case, the ID and the path indication of a node are different from each other. The ID assigned to the node thus exists in addition to the path indication. The purpose of the path indication is, among other things, for the nodes of the data model to be intuitively addressable via the path structure, while the ID serves to address the node by a short identifier.

Moreover, the apparatus includes a controller 120 including a writing function for each attribute of each one of the three or more nodes of the data model which has attributes, and the value of the attribute being changeable by means of the writing function.

In addition, the apparatus includes a synchronizer 130. The synchronizer 130 is configured to receive an update notification designating one of the nodes of the data model 110, said update notification further designating an attribute of said node, and the update notification indicating how the value of this attribute is to be updated, the update notification designating the node by means of the ID of the node.

The controller 120 is configured to update the value of this attribute of this node as a function of the update notification by means of the writing function of this attribute.

In this context, the data model 110 may comprise a graph-shaped structure. For example, it may be specified that a node “root” precedes the node “Renderer”. This relationship may be defined and/or indicated as a graph of from “root” to “Renderer”. Moreover, it may be specified, for example, that the node “Renderer” precedes the node “Scene”. This relationship may also be defined, or considered as, a graph of from “Renderer” to “Scene”. All of such relationships then result in the graph-shaped structure of the data model 110.

The data model 110 may comprise a tree-shaped hierarchic structure, which may be considered to be a special case of a graph-shaped structure. In a tree-shaped hierarchic structure, there typically exists a root node which is mediately or immediately followed by all of the further nodes of the data model. Such a tree-shaped hierarchic structure is depicted in FIG. 1b.

For example, a path indication “root. Renderer.Scene.src0” may unambiguously designate the corresponding node src0 in a tree-shaped hierarchy such as the tree-shaped hierarchy of FIG. 1b. Such a path indication includes the node “src0” and three further nodes of the data model, namely “root”, “Renderer” and “Scene”. Using only “src0” as the name for unambiguously designating the corresponding node is possibly not sufficient since the node “src0” possibly comes up several times as a name in the data model.

An ID with which the node is briefly and unambiguously addressed may be a number, for example. For example, the node src0 might be designated by the ID “7”.

To differentiate the terms ID and path indication, the following explanation can be given. A simple ID has only one requirement: it may unambiguously address a node only throughout the system. It is therefore sufficient here to simply number all of the nodes, for example.

As a rule, a path indication exhibits further properties which go beyond the ID: it includes local node names which describe a pathway from the root of the graph up to the node to be addressed, via intermediate nodes. Contrary to the global ID, the local node name may be unambiguous only for the node and its sibling nodes. By combining the local node names of a node with the local node names of the parent and/or predecessor elements of a node, the path indication results which is also unambiguous throughout the system.

In one embodiment, the ID of each of the three or more nodes of the data model may be a number or a string or a hash value, for example.

In one embodiment, the controller 120 includes, for each attribute of each of the three or more nodes of the data models which comprises attributes, a reading function, the value of the attribute being readable by means of the reading function.

For example, in a specific embodiment, the synchronizer 140 may be configured to receive the update notification, to determine, with the ID contained therein, a pertinent controller subunit of the controller 120 that is responsible for this node (for this purpose, the synchronizer 140 possesses, e.g., a dictionary/a map which stores a reference to a controller subunit for each ID), and to then convey to same a piece of information which contains the name of the attribute to be changed and the value. The controller subunit of the controller 120 will then change the data model 110 with the aid of the writing function.

In accordance with one embodiment, the synchronizer is configured to receive the update notification designating said node of the data model, the update notification further designating said attribute of this node, and the update notification indicating how the value of this attribute is to be updated, the update notification designating the path indication of the node, the controller being configured to update the value of this attribute of this node as a function of the update notification.

In one embodiment, the three or more nodes of the data model form a graph-shaped, e.g., tree-shaped, hierarchy, so that each node of the data model is immediately followed by at least one of the nodes of the data model in the graph-shaped hierarchy and/or is immediately preceded by at least one of the nodes of the data model in the graph-shaped hierarchy, at least one of the nodes of the data model being immediately followed by two nodes of the data model in the tree-shaped hierarchy.

FIG. 1b shows such a graph-shaped data structure by using the example of a tree-shaped hierarchic data structure of the data model in accordance with an embodiment. In the tree-shaped hierarchy of the data model, the nodes “DHD®” and “Renderer” immediately follow the node “root”. Conversely, the node “root” immediately precedes the nodes “DHD®” and “Renderer”. The node “Renderer” is immediately followed by the nodes “LSSetups”, “Scene”, “Spatial Sound Wave”, and “WavPl”. Conversely, the node “Renderer” immediately precedes the nodes “LSSetups”, “Scene”, “Spatial Sound Wave” and “WavPl”, etc.

In accordance with one embodiment, the apparatus further comprises an interface configured to receive information about changes of the data model which add one or more attributes to one of the nodes of the data model, the apparatus being configured to automatically generate a reading function and a writing function for each of said added one or more attributes, the value of said attribute being readable by means of the reading function and the value of the attribute being changeable by means of the writing function.

In embodiments, not only does the generated writing function change the value of the local data model, for example, but it simultaneously ensures that the synchronizer is informed about the change, that change events are propagated within the system and/or that connected observers can react to the change and/or that further things are caused to be done, such as recording of automation data, undo/redo, etc.

In one embodiment, the apparatus is configured to provide the reading function and the writing function for each of the attributes of each of the nodes of the data model which comprises attributes by means of a web application, so that said reading function and said writing function can be used by means of the web application. In one embodiment, the web application may be implemented in JavaScript and/or HTML, for example.

In accordance with one embodiment, the apparatus is configured to install change monitoring for one of the attributes of one of the nodes of the data model upon a user input.

For example, said change monitoring may be configured to send, or trigger, an “event”.

For example, the apparatus may be configured to output an alert when a value of one of the attributes for which change monitoring has been installed changes.

For example, in order to indicate an alert, one can register an observer to the event. Said observer will receive the event and will then output an alert. However, the reaction may be any reaction different from outputting an alert.

In accordance with one embodiment, a server is provided. The server is an apparatus as was described above. Moreover, the server is configured to receive a registration from one or more clients. In addition, the server is configured to transfer information about the data model to the one or more clients upon their registration, said information about the data model including the values of the attributes of all of the nodes or of two or more of the nodes of the data model which have attributes, and the information about the data model further indicating, for each node of the data model or for the at least two nodes of the data model, which of the nodes of the data model immediately follow said node and/or which nodes of the data model immediately precede said node. The data model also contains the node IDs, for example.

In one embodiment, the server is configured to receive a registration from two or more clients, the synchronizer of the server being configured to receive a message from one of the clients which indicates that a value of an attribute of a node of the data model has changed, and the synchronizer of the server being configured to inform the other two or more clients who have registered with the server, upon the message of said client, of the fact that a value of an attribute of a node of the data model has changed.

Conversely, the server may also receive the data model and updates from a client. This may be useful, for example, when the client has worked, for example, without any connection to the server for a relatively long time period, e.g., has worked offline.

In accordance with one embodiment, the server is configured to send a message to a device in a wireless or wired manner, said message letting the device know that an attribute of one of the nodes of the data model has changed.

In one embodiment, the apparatus is configured to send the message to the device in a wireless manner, e.g., by means of WLAN, by means of GPRS, by means of UMTS or by means of LTE.

In accordance with one embodiment, the device is a renderer for producing one or more loudspeaker signals. In one embodiment, the device may also be a DHD® audio matrix. For example, the connected clients may be a (3D) audio work station, an audio plugin (VST/RTAS/AudioUnits etc.) and/or an IPad® app.

In one embodiment, the server is configured to receive from the client information about the data model of the client, said information about the data model of the client including the values of the attributes of all of the nodes or of two or more of the nodes of the data model of the client which have attributes, and the information about the data model of the client further indicating, for each node of the data model of the client or for the at least two nodes of the data model of the client, which of the nodes of the data model of the client immediately follow said node and/or which nodes of the data model of the client immediately precede said node.

In accordance with a further embodiment, a client is provided. The server is an apparatus as was described above. Moreover, the client is configured to register with the above-described server. The client is configured to receive, upon registration with the server, information about the data model of the server, said information about the data model of the server including the values of the attributes of all of the nodes or of two or more of the nodes of the data model of the server which have attributes, and the information about the data model of the server further indicating, for each node of the data model or for the two or more nodes of the data model of the server, which of the nodes of the data model of the server immediately follow said node and/or which nodes of the data model of the server immediately precede said node. Moreover, the client is configured to update its data model as a function of the information about the data model of the server.

In one embodiment, the client is configured to transfer to the server information about the data model of the client, said information about the data model of the client including the values of the attributes of all of the nodes or of two or more of the nodes of the data model of the client which have attributes, and the information about the data model of the client further indicating, for each node of the data model of the client or for the at least two nodes of the data model of the client, which of the nodes of the data model of the client immediately follow said node and/or which nodes of the data model of the client immediately precede said node.

In accordance with one embodiment, the client may be configured to create object-oriented audio scenes.

FIG. 1c shows a system in accordance with an embodiment.

The system includes the above-described server 170 and the above-described client 160. The client 160 is configured to send an update notification to the server 170. The synchronizer of the server 170 is configured to receive the update notification, which designates one of the nodes of the data model of the server 170, which moreover designates an attribute of said node and which indicates how the value of said attribute is to be updated. The controller of the server 170 is configured to update the value of said attribute of said node as a function of the update notification if the update notification designates the ID of the node.

In the following, fundamental concepts of embodiments will initially be explained. Subsequently, advantageous embodiments and their concepts will be described in detail.

Embodiments provide a general mechanism which combines the advantages of key-value-based databases with document-oriented approaches. The aim is to synchronize data structures which are structured in the shape of graphs with one another in real time and/or with low latency and/or low delay.

In accordance with embodiments, the approach in developing an application is as follows:

A graph-shaped data structure is defined which represents the data of the application. The data structure may be a JSON or XML dataset (JSON=JavaScript Object Notation; XML=Extensible Markup Language).

By means of a code generator, the executable controller and data model code is generated from the graph-shaped data structure. This may occur either on the server side or on the client side. The code thus generated includes, e.g., routines for reading and writing the data into the graph model, routines for notifying observers interested in changes as well as routines for transmitting the changes in the data model to a central server and/or clients connected thereto.

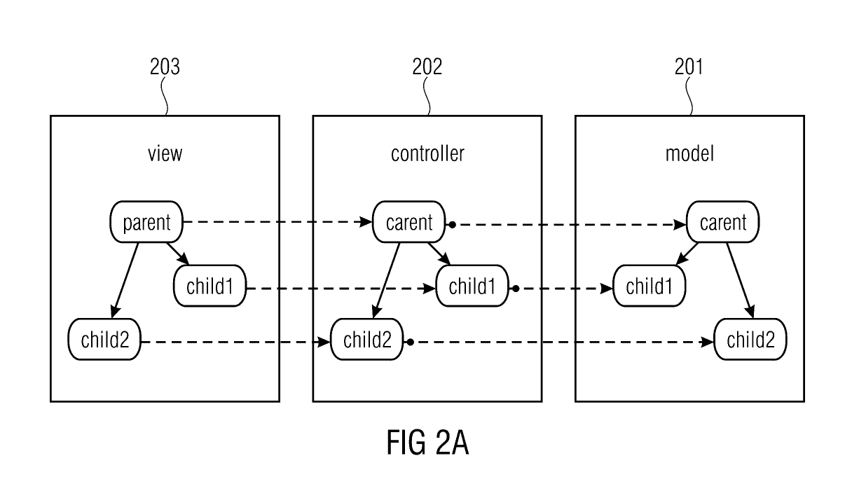

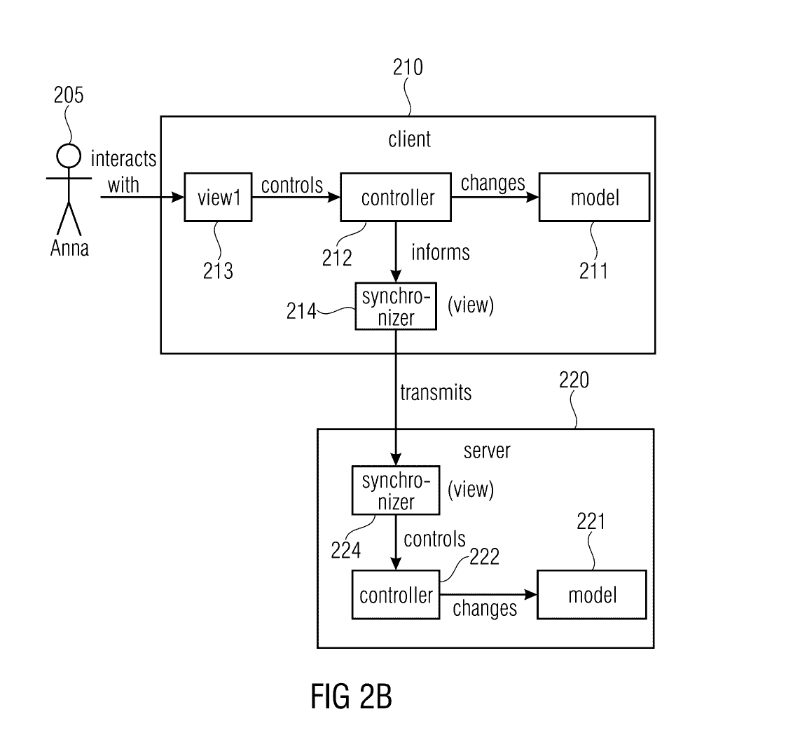

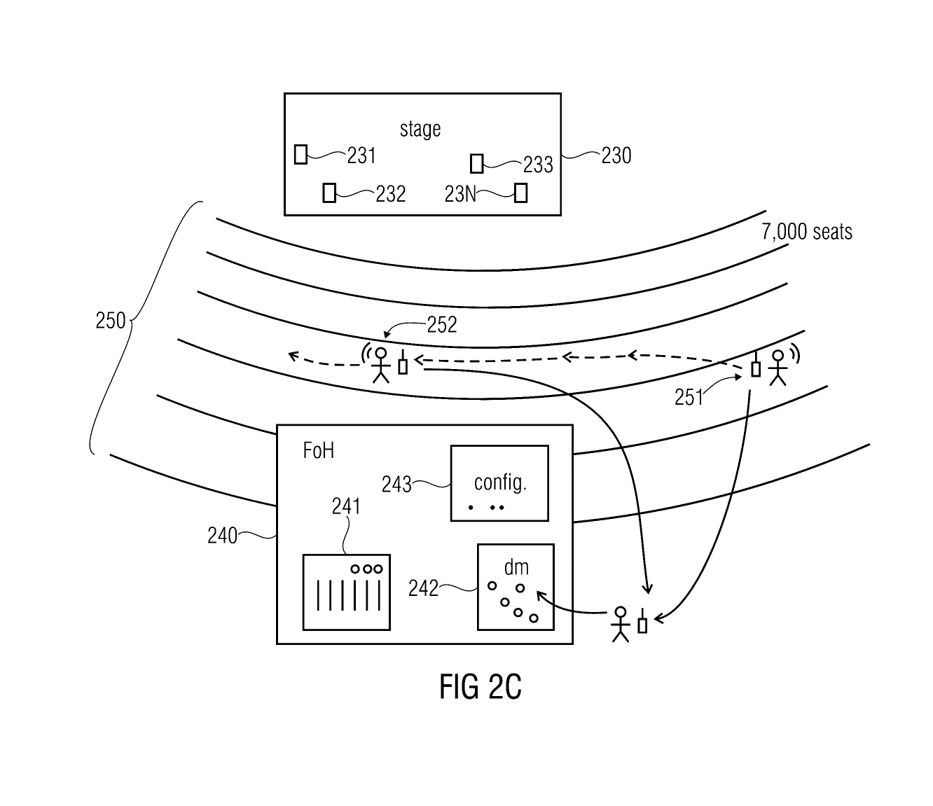

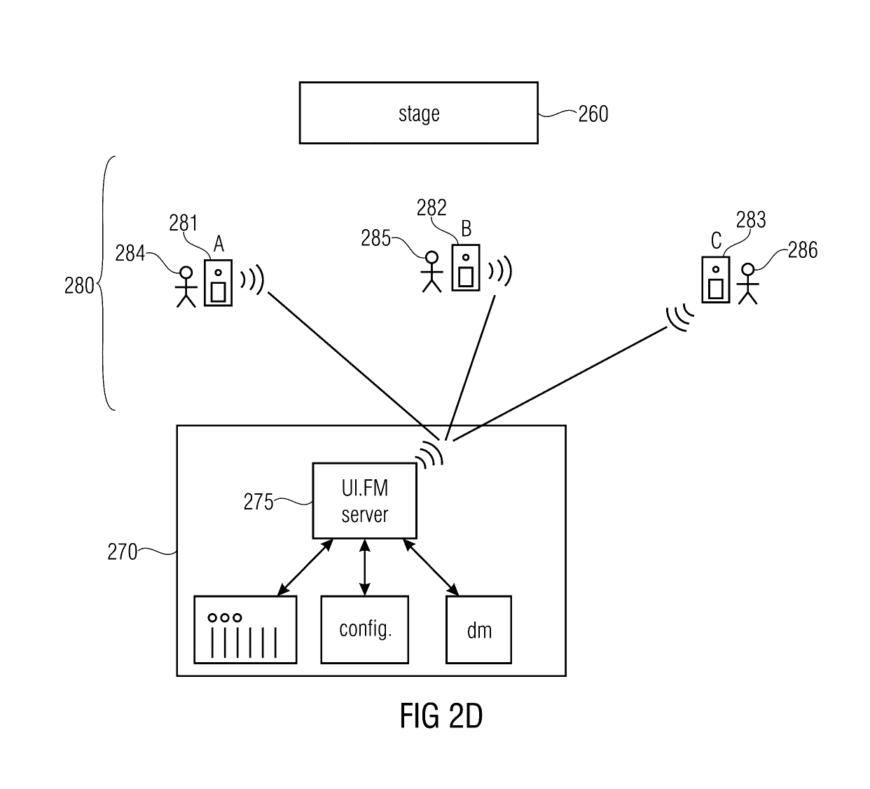

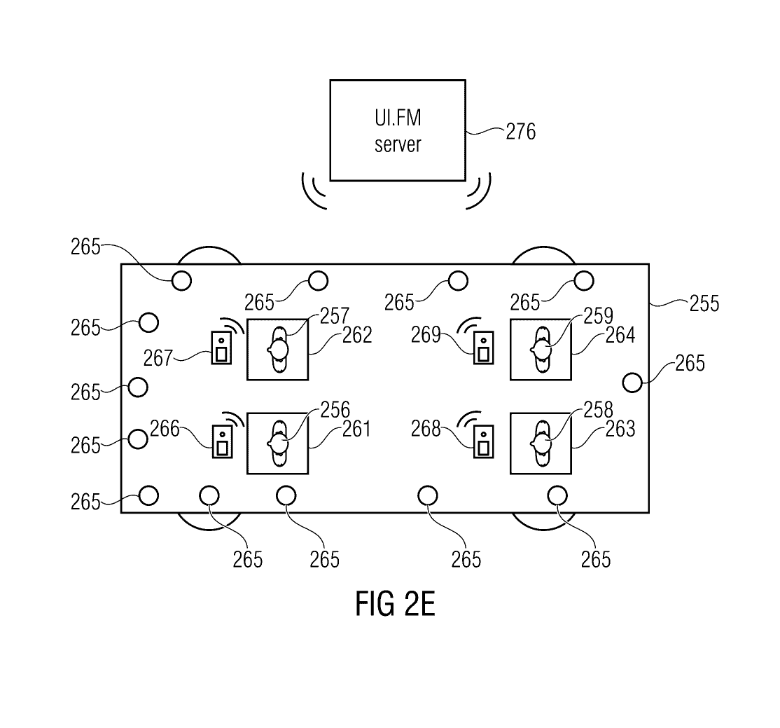

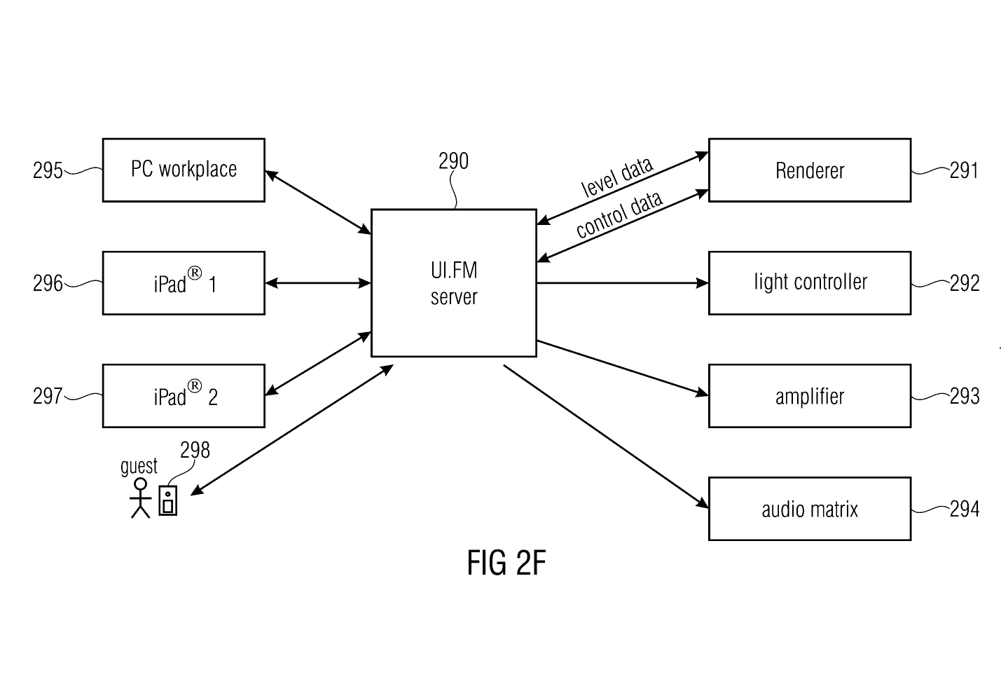

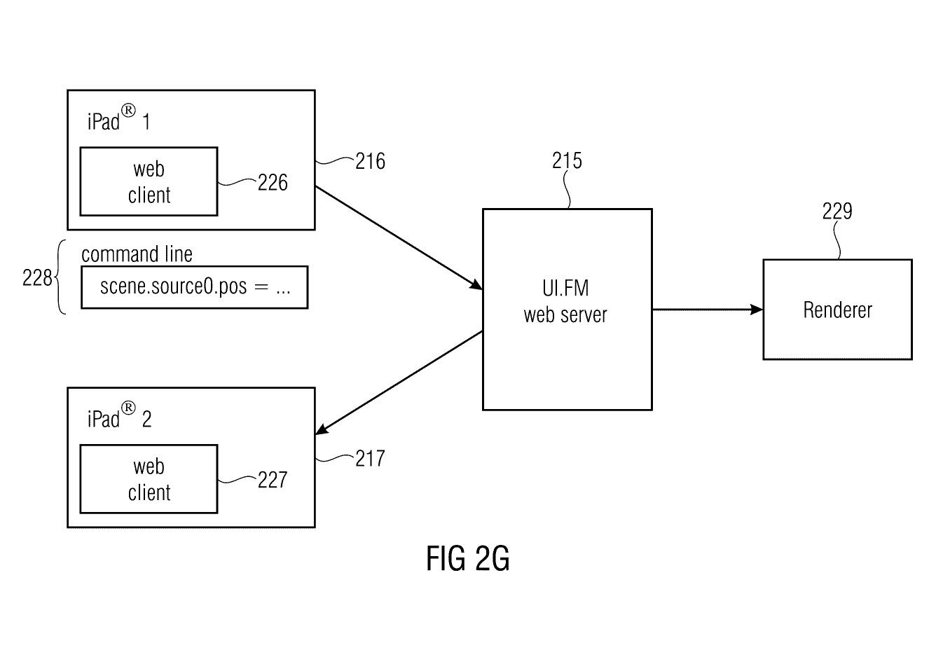

FIG. 2a shows three structures, namely a data model (model) 201, an observer structure (view) 203 as well as controller structure (controller) 202, which are automatically generated on the basis of an original data model, which has the shape of a graph.

The generated controller structure 202 already includes the code for synchronizing the tree hierarchy with the server and, thus, also with other clients. Synchronization may be effected from the client to the server and/or from the server to the client.

FIG. 2b shows a possible course of the synchronization between a client 210 and a server 220. In FIG. 2b, the client 210 includes a data model 211, a controller 212, a view 213 and a synchronizer 214. The server 220 in FIG. 2b includes a data model 221, a controller 222 and a synchronizer 224.

For example, if a user (Anna) 205 changes something, the controller 212 of the client 210 will be notified of this. The controller 212 of the client 210 will change the tree-shaped data structure (model) 211 and will simultaneously also inform the synchronizer 214 of the client 210 by means of an update notification. All this is effected, e.g., with the aid of the automatically generated writing function.

The synchronizer 214 of the client 210 transmits the change to the server 220, e.g., to the synchronizer 224 of the server 220, in an update notification. The server 220 in turn will enter the change into its local data model 221, e.g., by means of the controller 222 of the server 220, upon the update notification. In addition, the server 220 will simultaneously also transmit the change to all of the clients (not depicted in FIG. 2b).

If the server or a client application starts, they will initially load the definition of the graph-shaped data structure and generate the application code with the aid of the above-mentioned code generator.

The code generator may be loaded from a hard disk, for example, or may be transmitted from the server to the client during registration, for example.

Moreover, for example, each of the nodes of the graph-shaped data structure will have an ID associated with it that is unambiguous for the client.

The ID can be generated as follows, for example. Each client is initially given a client ID that is unambiguous throughout the system. If a client generates a new node, a locally unambiguous node designator will be combined with the client ID to form a node ID that is unambiguous throughout the system. As a consequence, central ID generation will no longer be necessary once the client ID has been transmitted. The advantages particularly consist in that for generating new nodes in clients, no server queries will be required. Thus, the client will be able to generate IDs that are unambiguous throughout the system even when said client is offline. However, the prerequisite for this is that the client has been connected to said server at least once. Nodes locally generated within the client are to be transmitted (at a later point in time) e.g., to the server and the remaining clients and to be attached to the local data structure there. However, renaming of IDs will no longer be necessary.

For example, the ID remains valid only during run time. With the aid of this ID it will later on be possible to directly address each node of the tree. Instead of a long path address such as “/trunk/branch/twig/leaf/cell”, the node of the tree may then also be addressed via the ID which represents a short hash, e.g., “0d4”. This is of significance specifically for applications having a high level of data traffic.

Once the client and the server have been started, the data structures may undergo initial mutual matching. If the client has worked offline for a while it will often be useful to match the data structure from the client to the server, e.g., in that the client informs the server about the current data structure of the client so that the server may adapt its data structure, for example. However, if the client wishes to download the existing application from the server at a later point in time, the data structure will have to be matched, e.g., from the server to the client, for example in that the client obtains the server's data structure from same.

If one assumes, for example, that the data is to be matched from the server to the client, this can be effected as follows, for example:

In a first step, the node IDs between the client and the server may be matched, i.e., pertinent nodes on the client side and on the server side may have the same addresses. To this end, the server generates an ID tree, for example, which has the same structure as the data tree but initially contains only the IDs. Alternatively, the server and/or the client might also transmit a table, for example, which associates paths with IDs. This ID tree is transmitted to the client. The latter replaces the existing IDs by those of the server. Observers (views) of the tree will also be informed about the renaming of the IDs.

Following this step, the actual tree data are transmitted from the server to the client. Here are two possibilities of how this may operate, for example.

Example 1: A first possibility is to transmit the tree data to the client as a tree-shaped data structure and to parse (enter) it into the corresponding nodes.

Example 2: A second possibility is to transmit the tree data individually, node by node, from the server to the client. To this end, for example the data of the respective node is packed into a data packet along with the node designator, or node name, and transmitted to the client. The latter may determine the pertinent node with the aid of the node designator and may write the corresponding data into said pertinent node.

The first possibility is used for initially transmitting relatively large data structures from the server to the client and/or vice versa. The second possibility is used for effectively exchanging between the client and the server any changes that are small but occur frequently.

In order to connect several clients to one other it is sufficient, in this context, for the server to simply forward the data packets it obtains from a client to the other clients. By means of the system proposed here all of the clients have the same tree structure and the same IDs. Each of the clients is thus able to comprehend any messages of change of the other clients.

Embodiments combine the performance advantages of key-value addressing (key-value databases) with the possibilities of document-orientated approaches (e.g., XML, JSON data) and of automated code generation.

Key-value addressing of data enables fast mechanical access to data. In this manner, high-frequency, low-latency synchronization of software applications is ensured.

The document-oriented approach simplifies administration of large data sets structured in a complex manner. As a result, it is very simple to access the data, for example on the part of an application developer. Applications consequently can be developed fast and efficiently.

Automatic code generation enables creating recurrent code components such as controller, publisher, parser, serializer, synchronizer, reading and writing functions to be generated from the graph-shaped data structure in an automated manner. This enables further reduction of the duration of development of distributed software applications.

Likewise, automatic code generation from a graph-shaped data structure also saves time and cost for developing distributed software applications. Extension of the graph-shaped data structure automatically also signifies extension of the protocol, extension of the parser, of the serializer, etc., of the synchronizer, etc.

Synchronization between the graph-shaped data structures is effected in a manner that is absolutely transparent to the application developer. The application developer simply defines its data structure, the rest is done by the code generator.

Due to the fact that both each client and the server possess the entire data model (or, in accordance with embodiments, at least part of the data model) it is possible to let clients work offline and to synchronize them later. At the same time, the stability of the system is clearly increased. Each client can thus simultaneously operate as a backup of the server.

A significant field of use of embodiments is the field of web development. The code is typically openly transmitted as JavaScript, Ruby or the like rather than in the form of a machine code.

Technical fields of application are, for example, collaborative distributed real-time applications such as controlling and monitoring of machines, controlling and monitoring of audio system, distributed software applications in general, and web applications.

Embodiments have been implemented as a user-interface framework (UI.FM), which may be web-based, for example, and which renders the development of distributed applications clearly more user-friendly and more cost-efficient and designs them in a cross-platform manner.

Some embodiments may be used, for example, for acoustically installing 3D audio systems simultaneously from several listening positions, e.g., within a stadium.

FIG. 2c shows an example without the use of UI.FM. FIG. 2c represents the lake stage of Bregenz. At the front, the stage 230 is depicted. A large number of loud speakers 231, 232, 233, 23N are installed on the stage 230. In the area of the audience, once sees the FoH 240 (“Front of House”: The space in the center in front of the stage house, the location where the sound monitoring operator mixes the sound), which drives the loudspeakers 231, 232, 233, 23N in accordance with adjustable control parameters. The FoH includes a mixing desk 241, a direction mixer (dm) 242, configuration tools (config) 243, etc. The large audience area 250, 7,000 provides seats for persons, for example.

What is aimed for is that every member of the audience has an optimum sound. To this end, one will adopt the following approach, for example, if embodiments of the invention are not available: one go to a first seat, e.g., to a position 251 on the right-hand side. At this first position 251 one will listen to the sound and then transmit any change requests to the FoH 240 via mobile phone. At the FoH 240, parameters will be changed accordingly. One will then listen to the sound, and if one is contented with the sound one will move to a second position 252, e.g., one position further to the left. There, one will again listen to the sound accordingly and again transmit any change requests to the FoH 240 by radio. At the FoH, parameters will again be changed accordingly, at the second position 252 one will again listen to the changed sound accordingly and will then again perform matching with the FoH accordingly. Subsequently, one moves to the next position and continues the process accordingly. Such a process is very costly and laborious.

In the following, embodiments will be described in detail. The functionality of UI.FM will be explained. UI.FM is a new user-interface framework.

FIG. 2d shows an embodiment wherein the new solution is implemented. Again, a stage 260, an FoH 270 and an audience area 280 are depicted. However, in the example of FIG. 2d, only one UI.FM server 275 is installed. The UI.FM server 275 is connected to the components within the system. One can see three different terminal devices, namely twice an iPad® 282, 283 and an iPhone® 281. The terminal devices might also be any other suitable terminal devices.

For example, three sound engineers 284, 285, 286 may simultaneously move to different positions within the stands, each of the sound engineers 284, 285, 286 now being able to position, configure and/or set the sound. The changes are made via the respective mobile terminal device 281, 282, 283 in each case. The mobile terminal device 281, 282, 283 is connected to the UI.FM server 275, for example via WLAN. The end information is set within the UI.FM server 275 and will then control the components (not shown in FIG. 2d) within the studio room accordingly. For example, Config, Rim and mixing desk may be the components that are controlled.

Any changes effected by a sound engineer 286 on a terminal device 283 are immediately forwarded to the other terminal devices 281, 282. I.e., the other terminal devices 281, 282 are updated accordingly. This means that the other participants (e.g., in FIG. 2d: the other sound engineers) 284, 285 can immediately see what it is that one of the participants 286 has changed, can hear the change accordingly and immediately react to it. In other words, if one of the sound engineers located in the position C changes something that sounds very good in position C but not in position B, the person 285 located in position B can instantly react thereto, can perform a different setting and thus make changes again. This allows that the three persons 284, 285, 286 located in positions A, B and C may negotiate, e.g., control parameters with one another in an optimum manner. The embodiment of FIG. 2d thus represents a clear simplification and improvement as compared to what was explained above with reference to FIG. 2c.

A different application scenario, namely the installation of a sound system within a car, is shown in FIG. 2e. What can be seen is a vehicle, here a car 255, for example, having four seats 261, 262, 263, 264 therein. A sonication system comprising numerous loudspeakers 265 is installed within the vehicle accordingly. It is desired that an optimum sound is generated for each seat 261, 262, 263, 264.

To be able to implement this, four iPads® 266, 267, 268, 269 can be used within the car 255. Four sound engineers 256, 257, 258, 259 can now utilize the four iPads® 266, 267, 268, 269 within the car 255. For example, the four sound engineers 256, 257, 258, 259 within the car 255 can simultaneously set the sound with the aid of the iPads® 266, 267, 268, 269. For example, the four sound engineers 256, 257, 258, 259 within the car 255 can immediately hear the sound and negotiate an optimum (overall) sound with one another by means of the iPads® 266, 267, 268, 269, as was already explained in the example of FIG. 2d in the case of the lake stage of Bregenz. To this end, a UI.FM server 276 is employed to which the iPads® 266, 267, 268, 269 are connected via Wifi. Any changes that a user 256 performs on a device 266 are transmitted from the device 266 to the UI.FM server 276, and the UI.FM server 276 forwards the changes to the other devices 267, 268, 269. All of this is performed with a low level of delay.

FIG. 2f shows a further embodiment in accordance with an implementation wherein the audio laboratory of Fraunhofer Institut für Digitale Medientechnologie in Ilmenau is presented.

There is a large amount of server technologies here that are to collaborate with one another. Among other things, FIG. 2f depicts a renderer 291, in addition a light controller 292, further an amplifier 293, and 294 an audio matrix. On the left-hand side of FIG. 2f, a number of terminal devices are presented, for example a PC workplace 295, a first iPad® (iPad® 1) 296, a second iPad® 2 (iPad® 2) 297 and, e.g., a guest's terminal device 298. For example, a guest may also carry along his/her mobile phone 298 that is to collaborate with the other devices 291, 292, 293, 294, 295, 296, 297.

It may be desirable, for example, that the hardware 291, 292, 293, 294 on the right-hand side of FIG. 2f can be controlled by the devices 295, 296, 297, 298 on the left-hand side of FIG. 2f. For example, it is intended to enable all of the parameters to be set by the devices 295, 296, 297, 298 on the left-hand side of FIG. 2f.

The interconnection of the devices 295, 296, 297, 298 on the left-hand side of FIG. 2f with the hardware 291, 292, 293, 294 on the right-hand side of FIG. 2f is implemented by a UI.FM server 290. The UI.FM server 290 is connected, on the one hand, to the hardware 291, 292, 293, 294 on the right-hand side of FIG. 2f. For example, level data and control data is exchanged between the UI.FM server 290 and the renderer 291. Accordingly, the further hardware 292, 293, 294 on the right-hand side of FIG. 2f is also connected to the UI.FM server 290. Accordingly, the terminal devices 295, 296, 297, 298 on the left-hand side of FIG. 2f are also connected to the UI.FM server 290. When a user makes an entry, e.g. enters control information, via one of the iPads® 296, 297, e.g. via “iPad® 1” 296, said input will be transmitted to the UI.FM server 290 accordingly. The UI.FM server 290 will then pass said information on to the peripheral hardware 291, 292, 293, 294 on the right-hand side of FIG. 2f accordingly.

UI.FM comprises numerous advantages. For example, the UI.FM server may be implemented as a web server 215, for example, as is shown in FIG. 2g, and the clients, e.g., iPads® 216, 217, may implement web clients 226, 227. Thus, no software needs to be installed on the clients 216, 217, but the web server 215 delivers the software to the clients 216, 217 upon registration of the clients 216, 217. Due to the implementation as a web server 215 and/or as web clients 226, 227, a large amount of expenditure is saved.

A further advantage of UI.FM is that the system operates with low delay. Control parameters that are placed in one of the clients 216, which is implemented as a web client 226, for example, are instantly transmitted to the UI.FM server 215. The UI.FM server 215 then immediately transmits the control data to the one or more further clients, e.g. to a further iPad® 217. The (one or more) further client(s) 217 will then also have one web client 227 located thereon. The respective further web client 227 on the corresponding further terminal devices 217 will then immediately update the parameter in question. At the same time, the UI.FM server 215 will inform the connected periphery, for example a renderer 229, about the parameter update.

In accordance with one embodiment, the client may be configured to run in a web browser. The advantage is that, due to the fact that the program runs in the web browser on the client side, the application developer can open a command line (reference numeral 228 in FIG. 2g) within which he/she can directly enter commands. For example, in the embodiment of FIG. 2g, the command “scene.source0.pos=” . . . may be entered, whereby the position of “source0” may be changed, for example. Thus, the system is highly scriptable.

In one embodiment, the client may be configured, for example, to transmit to the server the ID of two or more of the nodes of the data model of the client.

In the following, a system and its components will be explained by means of an exemplary setup depicted in FIG. 3. It is understood that each single one of the components of FIG. 3 may be implemented by itself and thus represents one embodiment by itself. Moreover, it is understood that general methods and general implementations described with regard to one or more components of FIG. 3 may also be implemented generally and thus also represent, as a general method and/or as a general implementation, an embodiment of the invention.

For one thing, FIG. 3 represents a workplace PC 350. In addition, FIG. 3 shows a mobile iPad® 360. Moreover, FIG. 3 shows a renderer 380 and an audio matrix unit 390, e.g., a DHD® audio matrix unit. Moreover, FIG. 3 depicts a UI.FM server 300.

The renderer 380 may include submodules, e.g., a Spatial Sound Wave submodule 381. Moreover, the renderer 380 may hold a scene, for example, e.g., a scene unit 382. Moreover, the renderer 380 may include, e.g., a loudspeaker setup unit 383 for configuring a loudspeaker setup. Further submodules may exist. For example, a Way Player 384 may additionally be present. Similarly, the audio matrix unit 390 may comprise submodules. For example, the DHD® audio matrix unit 390 may include, e.g., a crosspoint matrix within a crosspoint matrix submodule 391.

The UI.FM server 300 is configured to map the real world as is depicted, for example, by the renderer 380 and/or the DHD® audio matrix, to a graph-shaped, e.g. tree-shaped, data model 310. For example, the representation of the UI.FM server 300 on the right-hand side of FIG. 3 depicts the data model 310. At the top in the data model 310, a root node (“Root”) is depicted. Underneath the root node, the DHD® audio matrix (“DHD®”) and the renderer are depicted. The node DHD® in the data model 310, which node represents the DHD® audio matrix 390, has a “crosspoint matrix” node located underneath it. Said representation of the crosspoint matrix 391 in turn comprises nodal points, for example x₀, x₁ and x₂. The representation of the renderer 380 within the data model 310 in turn has the nodes “speaker setup”, “Wav Player” and “Scene” located underneath it as subsequent nodes which represent the real submodules of the renderer 380. The scene in turn has sources, e.g., src0, src1 and src2. The sources src0, src1 and src2, for their part, also have properties, e.g., a position pos, a rotation rot, on/off, mute, etc. All of these submodules, attributes and relationships may be mapped by the data model 310. Thus, the data model 310 represents a memory configured in a particularly advantageous manner.

The interaction of the UI.FM server 300 and the peripheral hardware 380, 390 will be explained below:

For example, a particular difficulty arises when what is to be implemented is that, e.g., when the position of one of the sources src0, src1, src2 within the data model is changed, e.g., the renderer 380 will obtain said information and will also implement it in the form of a change of the position of the corresponding source, e.g., src0, src1 or src2, accordingly.

In order to implement a solution to this, a controller (control unit) 320 is introduced in the UI.FM server 300. For example, with regard to the src0 of the data model there is also a node src0 within the controller 320 of the UI.FM server 300. For each property of the source src0, e.g., for the properties “pos”, “rot”, “on/off” and “mute”, the controller 320 comprises a corresponding function for setting the value of the property and a corresponding function for reading out the value of the property. For example, the controller 320 provides a setPos(. . . ) function for setting the value of the property pos, and a Pos(. . . ) function for reading the value of the property pos. For example, if one wishes to change the position within the data model, one will call up the setPos(. . . ) function. In the setPos(. . . ) function, the current position to which the position is to be set is indicated, e.g., (1, 2, 3). By calling up the function setPos(. . . ) within the controller 320, the position pos within the data model is changed. When it is said that an attribute has a value, the term “value” is to be understood in a broad meaning and includes, e.g., numerical values, string values, i.e., values representing words or sentences, tuples of numerical values such as (1, 2, 3) or, e.g., tuples of string values, e.g., (“Hallo Welt”) (“hello world”), “code” and any other kinds of value types.

In addition to the mere possibility of specifying and changing values of attributes (properties), the setPos(. . . ) function moreover offers the possibility of informing connected views.

In one embodiment, a device, for example the renderer 380 or the DHD® audio matrix 390, has a message sent to it in a wireless or wired manner, said message informing the device that an attribute of one of the nodes of the data model 310 has changed.

In order to control, e.g., the renderer by means of such a message, a renderer driver 330 is to be programmed, for example, which represents a view, i.e., a view to the data model 310 and/or its attributes, and/or a view to the controller structure 320. By means of such views, the periphery, e.g., the renderer, can be controlled accordingly.

For example, the renderer driver 330 of the UI.FM server 300 can register as a view with the node src0 of the controller 320 of the UI.FM server 300. Thereby, the renderer driver becomes a view of the src0 node of the controller 320. If the position within the data model is set by calling up the src0.setPos(. . . ) function of the controller 320 of the UI.FM server 300, the view 330 (i.e., the renderer driver 330) will be notified accordingly at the same time.

Upon such notification the renderer driver 330 will then load the property pos of the src0 (i.e., position of the source src0), which has been updated, from the data model 310. However, the property may also be communicated to the renderer driver 330 within the framework of the notification. As a result, access to the data model is dispensed with.

In addition, the renderer driver 330 generates a protocol message and sends said protocol message to the renderer 380. For example, the protocol message may be an OSC control message (OSC=open sound control).

In addition to the renderer driver 330, or as an alternative to the renderer driver 330, the UI.FM server 300 may include further drivers which are also registered, e.g., to the source src0 of the controller 320, said further or alternative views exhibiting different behaviors, however. Again, for example when changing the property pos of the src0 (i.e., the position of the src0), the data model will be changed and all of the connected drivers (i.e., the drivers registered accordingly) are notified. The connected drivers generate corresponding protocol messages that are transmitted to the corresponding hardware periphery. Corresponding changes will then be performed in the hardware periphery.

The inverse manner of data transmission and updating is also possible: for example, a process may change, e.g., within the renderer 380, the position of, e.g., the src0. In this case, the renderer 380 will send a protocol message to the corresponding renderer driver 330. By such a message, the renderer driver 330 is notified of the fact that the corresponding position has changed, it calls up the setPos(. . . ) function of the src0 of the controller 320, and the value of the property pos of the src0 within the data model 310 will subsequently be changed.

To avoid that the renderer driver 330 be informed about a change in the position of the src0 that it himself has caused (possibly, but not necessarily, risk of an infinite loop) the renderer driver 330 of the UI-FM server 300 may specify that it does not want to be informed about a change in the position of the src0, e.g., a change it has caused itself.

By analogy therewith, further drivers, e.g., a renderer driver, e.g., for the DHD® audio matrix unit 390, may be implemented within the UI.FM server 300.

Further properties of the controller 320 of the UI.FM server 300 will be described below.

It should be noted that it is not only the source src0, but also the further sources src1 and src2 as well as the scene that are included in the controller 320. In other words, there is a controller subunit for each node within the data model 310.

This is an important property of the UI.FM server 300. Eventually, in addition to the data model hierarchy 310, which has a tree structure, a controller hierarchy 320 will result, which also has a tree structure analogous therewith. Said tree structure of the controller 320 will then look just like the tree structure of the data model hierarchy 310.

In accordance with embodiments, the data model hierarchy 310 of the UI.FM server 300 may be defined by the user. For example, the data model hierarchy 310 of the UI.FM server 300 may be fully defined by the user. For example, it is either possible for the controller hierarchy 320 to be produced from the data model hierarchy 310 or, conversely, the data model hierarchy 310 may be generated from the controller hierarchy 320. In an advantageous embodiment, the controller hierarchy 320 is defined, and the data model hierarchy 310 is derived therefrom.

Thus, one specific property of the UI.FM server 300 consists in that two parallel hierarchies, namely the controller hierarchy 320 and the data model hierarchy 310, coexist and are linked to each other. Thus, each node within the controller hierarchy 320 has a corresponding reference to the corresponding node within the data model hierarchy 310. For example, there may be a reference between the root node of the controller hierarchy 320 to the root node of the data model hierarchy 310. Thus, a connection exists between the controller and data model hierarchy 310 and the connected hardware periphery.

The connection between the control devices and the UI.FM server 300 and/or between the control devices and the controller hierarchy 320 and/or of the data model hierarchy 310 of the UI.FM server 300 will be described below.

In conventional technology, the data model 310 is organized within a database. In conventional technology, the client will further send inquiries to the database, will receive responses back from the database and will then be able to work with the data obtained.

Moreover, in accordance with conventional technology, the client may register on nodes of the data model 310 and will receive messages when the node of the data model changes. The data model itself may be stored within a database, for example. However, the organization of the data model 310 and of the manner in which the data model 310 is to be updated, for example, is left entirely up to the application developer in conventional technology.

In accordance with one embodiment, a mechanism is provided which relieves the user of a large amount of work. This mechanism will be explained in the following.

Upon the start of a client, e.g., of the workplace PC 350, the client registers with the UI.FM server 300 (see item (1) between the workplace PC 350 and the UI.FM server 300 in FIG. 3). Thus, the client initially registers with the UI.FM server 300.

The UI.FM server 300 will then transmit the controller hierarchy 320 to the client (see item (2) between the workplace PC 350 and the UI.FM server 300 in FIG. 3). Along with the controller hierarchy 320, the data model hierarchy 310 is also transmitted. This may be implicitly effected in that the client derives, e.g., the data model hierarchy 310 from the controller hierarchy 320 or, the data model hierarchy 310 is explicitly transmitted in addition to the controller hierarchy 320.

Due to the transmission of the controller hierarchy 320 (and possibly also in addition to the data model hierarchy 310), the same hierarchy exists both at the client and at the UI.FM server 300. I.e., the controller hierarchy 352 and the data model 351 are present at the client, e.g., the workplace PC 350.

The transmission of the controller hierarchy 320 and the data model hierarchy 310 may also be performed for further clients such as, e.g., in addition to the workplace PC 350, also for, e.g., an iPad® 360 if same register with the UI.FM server 300. Thus, the iPad® 360 in FIG. 3 comprises a controller hierarchy 362 and a data model 361, just like the workplace PC in FIG. 3.

The controller hierarchy 352 of the workplace PC 350 comprises a “root” and, in addition, similarly to the controller hierarchy of the UI.FM server 300, the nodes connected downstream from the “root”, e.g., among others, src0 and its downstream nodes. The same applies to the data model within the clients, e.g., to the data model of the workplace PC 350 and to the data model of the iPad® 360. The source src0, for example, is found in their controller hierarchies 352, 362 as well.

Within each client that registers with the UI.FM server 300, the same data model structure 351, 361 is initially installed as is installed in the UI.FM server. This applies, e.g., to the controller hierarchy 362 and to the data model 361 of the iPad® 360. Thus, all of the controller hierarchies 352, 362 and data models 351, 361 of the clients 350, 360 have been matched with the data model 310 and to the controller hierarchy 320 of the UI.FM server 300.

In addition, actual data transmission takes place from the server to the client (see item (3) between the workplace PC 350 and the UI.FM server 300 in FIG. 3). Thus, it is actually useful in order to transmit not only the hierarchic structures of the controller hierarchy 320 and of the data model 310 from the server 300 to the client 350, but also precisely the actual data, i.e., for example, concerning the values which the attributes within the data model have in each case (i.e., which value(s) the position pos of the sources src0, src1, src2, respectively has, etc.).

In accordance with embodiments, each node of the controller hierarchy 320 of the UI.FM sever 300 has an ID associated with it. The ID serves to quickly address nodes. Thus, normally a complete path would have to be indicated due to the graph-shaped structure of the controller hierarchy 320 and of the data model 310, e.g., “root/Renderer/Scene/src0”, so as to address a specific element within the data model and/or within the controller hierarchy. Due to the fact that each node now has an ID assigned to it, one will have a short identifier for each of the nodes and will thus be able to address the respective node by its identifier. Figuratively speaking, there is a short “telephone number” for each node, which telephone number can be used instead of indicating a long path. For example, in the controller hierarchy 320 of the UI.FM server 300, the node “root” has the ID 0, the node “DHD®” has the ID 1, the node “Renderer” has the ID 2, the node “LSSetups” has the ID 3, the node “WavPl.” (Way Player) has the ID 4, the node “coupling point matrix” has the ID 5, the node “Scene” has the ID 6, the node “src0” has the ID 7, the node “src1” has the ID 8, etc.

Accordingly, the IDs are transmitted from the UI.FM server 300 to the client 350 (see item (4) between the workplace PC 350 and the UI.FM server 300 in FIG. 3) and written into the data model 351 and into the controller hierarchy 352 of the client 350, for example into the data model 351 and into the controller hierarchy 352 of the workplace PC client 350.

Thus, the data transmission is followed by the ID transmission. That is, an ID tree is generated which has the same structure as the controller hierarchy. The difference is that the individual nodes have the IDs located therein. The IDs are then written into the corresponding nodes.

In the above explanations it shall be understood that the items (2), (3) and (4) may be performed in any order desired in the initialization of the client 350 at the UI.FM server 300.

In the following, an example in accordance with an embodiment shall be explained wherein a (sound) source is repositioned by means of a workplace PC 350. In other words, a web application running on a workplace PC 350, for example, is used for repositioning the spatial position of a, e.g., virtual (sound) source. For example, there may be a scenario wherein, e.g., the respective sound of three sound sources is picked up in three separate audio signals.

When said three audio signals are mixed into one overall signal at a later point in time, the three audio signals will be mixed in accordance with the virtual position of the sound source. For example, if the virtual position of a first sound source is located far away from the assumed position of the listener, the portion of its audio signal in terms of the overall signal is typically smaller than the portion of the audio signal of a second sound source, the virtual position of which is located close to the assumed listener position.

It is also possible, however, to produce a plurality of loudspeaker signals from the, e.g., three audio signals of the three sources. If, e.g., the virtual position of a first sound source is located far away from the (assumed) position of the loudspeaker considered in each case, the portion of its audio signal in terms of the loudspeaker signal is typically smaller for this loudspeaker than the portion of the audio signal of a second sound source, the virtual position of which is located close to the (assumed) loud speaker position.

By means of the above mentioned web application on the workplace PC 350, the (virtual) positions of the (sound) sources may thus be set, whereby one can control, from the workplace PC 350, how the renderer 380 mixes the individual audio signals of the sources into an overall signal or into a plurality of individual loudspeaker signals.

In order to be able to move the respective source, a view 353 is installed at the client (e.g., the workplace PC 350). To this end, the workplace PC 350 includes this view 353.

A source 358 is represented in the view 353 of the workplace PC 350 in FIG. 3. The source 358 is indicated, e.g., by a touch screen, can be touched by a finger and be moved, e.g., by being pulled. When this movement takes place, an event is triggered, for example.

Movement of this source on the part of the user results in that, e.g., the source is moved to a new position, e.g., to the position (x, y, z)=(8, 9, 10). This position is set, via the function setPos(. . . ), which is part of the controller hierarchy, at the source src0 accordingly. The controller 352 of the client 350 at the same time includes an update mechanism, which was already discussed, mutatis mutandis, in connection with the UI.FM server 300. Just like the UI.FM server 300, the workplace PC 350 also has a view 353. The setPos(. . . ) function that is called up when the source is moved sets a position within the data model of the workplace PC.

The change in position of the source within the data model 351 of the workplace PC 350 is subsequently transmitted to the UI.FM server 300. In accordance with embodiments, the above-described ID is used for data transmission. In this context, for example, a unit—of the controller of the PC 350—that is responsible for src0, informs a synchronizer 354 of the workplace PC 350.

One can imagine the synchronizer 354 as being some kind of view that will be informed when data changes. For example, the synchronizer 354 uses the corresponding ID and generates a message which states, for example, that the position has changed within the node with the ID 7, and what the value of the corresponding position is (e.g., (8, 9, 10)). Said update notification generated by the synchronizer 354, e.g. a message “7: Pos: (8, 9, 10)”, is transmitted to the UI.FM server 300.

Thus, also on the UI.FM server 300 there is a synchronizer 340 receiving the new position, transmitted by the update notification, of the src0. The synchronizer 340 of the UI.FM server 300 transmits the received position to the node having the corresponding ID, that is, in this case, e.g., the node having the ID 7.

The synchronizer 340 of the UI.FM server 300 subsequently determines, by means of the ID, the corresponding node of the controller 320. For example, the synchronizer 340 determines that the node having the ID 7 is the node src0, and calls up the setPos(. . . ) function of the src0 controller node.

The setPos(. . . ) function enters the position into the data model 310 of the UI.FM server 300 and additionally notifies the renderer driver 330 of the new position. The renderer driver 330 for its part hands over the new position to the renderer 330.

As far as the synchronizer 300 of the UI.FM server 300 is concerned, the message regarding the workplace PC 350 is passed on from the synchronizer 340 to all further clients, e.g., to the iPad® 360, with a minimum time delay. The iPad® 360 has the same controller hierarchy 362 and data structure 361 having the same IDs as does the UI.FM server 300. Moreover, the iPad® 360 additionally includes a synchronizer 364. The synchronizer 364 of the iPad® 360 likewise enters said ID into its data model 361. If the iPad® comprises views (in FIG. 3 the view 363, for example), the controller 362 will transmit the information from the synchronizer 364 about the changed position not only into the data model 361 of the iPad® 360, but additionally also into the view 363 of the iPad® 360. Thus, the view 363 of the iPad® 360 is updated.

Instead of using the workplace PC 350, a user may move a source also on the iPad® 360, by analogy with the above description. The information would be written, by analogy, via the setPos(. . . ) function of the controller 362 of the iPad® 360. The controller 362 of the iPad® 360 would update the data model 361 of the iPad® 360. Moreover, the controller 362 of the iPad® 360 would inform the synchronizer 364 of the iPad® 360. The synchronizer 364 of the iPad® 360 would transmit said information to the synchronizer 340 of the UI.FM server 360 in an update notification. The synchronizer 364 of the UI.FM server 360 would directly pass on the information contained within the update notification to synchronizers of other clients, e.g., to the synchronizer 354 of the workplace PC 350. Moreover, the synchronizer 340 of the UI.FM server 300 would set said information also within the controller 320 of the server 300. The controller 320 of the UI.FM server 300 would update the position of src0 within the data model 310 of the server 300. Furthermore, the controller 320 of the server 300 would notify the corresponding driver of the server of the change in position. Said driver, which here thus is the renderer driver 330, would inform the renderer 380 accordingly.

Specific advantages of the concepts provided will be presented in accordance with embodiments below.

In accordance with embodiments, the code implementing the above-described functionality is suited to run in the web browser. In one embodiment, it is possible, for example, to call up the server side via the browser, e.g., a URL. The code for the workplace PC 350 is transmitted live and will then be executed instantly on the workplace PC 350. In this manner, complex installation processes are dispensed with.

A further major advantage relates to documentation. Since the entire data model hierarchy is transmitted to the client, e.g., to the workplace PC 350, a system description that is very easily comprehensible in a semantically intuitive manner will be present there. Said system description can easily be accessed on the client 350. Moreover, the system description will then also be present in a comprehensible form due to its hierarchiclly structured tree structure. As a result, documentation expenditure is dispensed with.

Embodiments provide means for dynamic code generation, e.g., dynamic generation of executable code. The system is web-based, it being possible to use functions to generate other functions. Said other functions that have been generated can then be executed. This means that the user needs to define the controller hierarchy only to a minimum extent and that any other code for synchronizing for assigning IDs etc. can be automatically generated.

For example, the user may simply define that the source src0 has a property, e.g., a position (x, y, z), with the standard value (x, y, z)=(0, 0, 0). In embodiments, the system is configured to automatically generate two functions from said information, e.g., the function “Pos( )” so as to read the value of the attribute pos of the src0, i.e., to have the value of the position of the source src0 returned to it, and the function setPos(. . . ) so as to set a new value for the attribute pos of the source src0, e.g., “setPos(8, 9, 10)”, whereby the value of the attribute pos may be set to be (x, y, z)=(8, 9, 10).

In that the application developer once stores the information that, e.g., an attribute pos has the standard value (0, 0, 0), in embodiments both above functions are automatically generated, specifically for each of the clients, e.g., in the workplace PC 350, in that the clients take over the controller hierarchy. In other words, an extremely small amount of information may be used for defining such a controller, e.g., such a controller unit of the node src0.

A further advantage is that embodiments of the invention enable intuitive access, on the one hand, and enable access to nodes of the data structure which simultaneously is very fast, on the other hand. Thus, embodiments combine both the property of intuitiveness and the property of speed, whereas conventional systems are normally either intuitive or fast, but not both.

The intuitiveness of the data structure is especially important to the application developer. When the application developer wants to set information within the data model, said application developer may have a relatively simple path made available to him/her of how he/she obtains the information of the source src0.

In accordance with one embodiment, the system generates an instruction set for this purpose by means of which individual nodes are easily addressable within the browser. For example, one can open a command line within the browser. The user or application developer may enter the following into said command line: “root.Renderer.Scene.src0.setXyz(8, 9, 10)”. Such a line is highly intuitive when one knows the corresponding structure of the graph-shaped data structure. Thus, one can very easily, i.e., intuitively, access information of the data structure, load information, update information. In all of this, the documentation expenditure becomes very low since the data structure is already apparent from its hierarchic tree-shaped architecture.

In accordance with embodiments, once the tree structure has been defined, commands are automatically generated which enable, e.g., in JavaScript, the dot operators between the nodes. For example, in embodiments, the browser and/or the server command line generates said dot operators. In this context, the controller structure is configured such that said operators may be used in a simple manner.

In embodiments, a path leading to a desired node is also indicated by the fact that, e.g., starting from root nodes or starting from one of its successor nodes, the consecutive nodes up to the desired node are indicated one by one, consecutive nodes being separated by a dot in each case. For example, the node src0 may be accessed, e.g., by indicating the path “root.Renderer.Scene.src0” or, e.g., by indicating the path “Renderer.Scene.src0” (for example when it is clear that the root node “root” is the first node). If node names are not unambiguous, it is not sufficient to simply indicate “src0” for access since it is possible that there will be, e.g., several nodes within a data structure which have the name of “src0”. In addition, the intuitiveness of the data structure would be lost as a result.

Intuitive as the paths described here may be for the application developer, they are inefficient when such nodes accesses are performed very frequently.

For example, in one embodiment, the renderer 380 may be configured to generate level data transmitted to the renderer driver 330 of the UI.FM server 300 via OSC messages accordingly. The renderer driver 330 will then set the level data within the controller hierarchy 320 and, thus, within the data model 310 accordingly. For 64 sources, these are 64 items of information, for example, which are updated 50 times per second, for example, i.e., in this example, 3,200 updates are made per second. In other parts of the system, further high-frequency information may regularly arise which have to be processed. For position updating, a path of the form of “root.Renderer.Scene.src0.posXyz(8, 9, 10)” would then have to be addressed each time. Such a command would be sent from the client, e.g., the workplace PC 350, to the UI.FM server 300 in a message each time. However, this is inefficient.

For a more efficient implementation, the IDs which have already been introduced above are used. Since each node possesses an ID which represents a kind of hash value, the ID acting as a short address, the ID may also be used as an alternative to the long path which is good for the human developer. One example would be the command “node[7].setXyz(8, 9, 10)”. In this manner, the function “setXyz(. . . )” of the node having the ID 7, i.e., the setXyz(. . . ) function of the node src0, is called up.

The IDs used here thus provide the possibility of addressing elements in a very short manner, which may render synchronization more efficient. If specific items of information change frequently, e.g., when a source is moved, which involves a very large number of updates, what will be transmitted from the client 350 to the UI.FM server 300 is not the above-described long path but the corresponding ID. This may also be effected, for example, by a short instruction of the form “7: pos: [8, 9, 10]” which states, for example, that the value of the attribute “pos” of the node having the ID 7 (i.e., src0) is to be changed to read (x, y, z)=(8, 9, 10).

The possibility of addressing elements in a very short manner may be advantageous when specific items of information change frequently and is useful in synchronization, for example.

For example, moving the source 358 entails a very large number of position updates. In this case, what is transmitted from the client to the server is not the long path but the ID. For example, by using data messages of the form “7: pos: [8, 9, 10]”, one will have very short data messages. These can then be transmitted to the UI.FM server 300 and to all clients, e.g., the iPad® 360, in a very efficient manner. Thus, the long path has the advantage that it is intuitive, in particular for human developers, whereas the short path, i.e., “7: pos: [8, 9, 10]”, for example, has the advantage of being very well processable for the system. Date transmission by means of the ID is very fast. Embodiments combine both advantages by providing both the long path and the short ID addressing.

In embodiments, both possibilities of addressing are generated by the system in an automated manner when the controller hierarchy and/or the data structure is defined.

Essential properties of the system will be described below.

Embodiments exhibit a multi-client ability. Multi-client capability means that one and the same application starts on several clients. For example, the same application can be started on the workplace PC 350, on the iPad® 360 and, e.g., on further devices. Each change that is made on a client, e.g., the workplace PC 350, is transmitted to all of the other clients 360. For example, the application is present on several screens simultaneously and is also visible simultaneously.

In a further example of application, a part of the application can be presented on a first client, e.g., the workplace PC 350, whereas other parts of the application can be presented, e.g., on a second client, e.g., an iPad® 360. For example, a source may be switched to mute on the iPad® 360 with the left hand, whereas a sound source is positioned on the workplace PC 350 with the right hand. Such a functionality can be referred to as a multi-device ability.

What is advantageous, in addition, is a web-based implementation in accordance with embodiments.

A further essential feature of embodiments is their ability to perform inquiries with low delay. For example, if a source 358 is moved within a browser of a client, e.g. of the workplace PC 350, said source movement will be transmitted almost without any time delay to the other clients, e.g., the iPad® 360, and will be visible there almost without any time delay. The same applies to level data coming from the renderer 380, for example. Thus, it shows that the system is fast enough to be able to process even very high-frequency parameter changes.

As was already mentioned, the controller 320 has different tasks, one task consisting in changing the data model 310, a further task consisting in informing the drivers, e.g., the renderer driver 330, to additionally trigger synchronization performed by the synchronizer 340.

Moreover, the controller 320, which is also implemented in UI.FM 300, comprises a further ability, namely the ability to record data changes over time. I.e., when a source is moved 358, said change can be recorded by the controller 320 and be reproduced at a later point in time. This may be used, e.g., for recording source movements. Accordingly, said recorded source movements can be reproduced, or played back, at a later point in time. This may be referred to as automation capacity.

What the controller hierarchy and the data model, i.e., the tree-shaped structure, look like specifically will be described below.

Embodiments have the property of automatic code generation, i.e., of automatic generation of the reading and writing functions for corresponding access to node attributes. This is referred to as dynamic code generation.

In embodiments, the synchronizer code, too, may be automatically generated. It is possible to automatically generate not only the access routines, i.e., the reading and writing functions, but also the synchronization functions.

Moreover, embodiments have the property that the code which notifies the views 363 can be automatically generated from the controller definition and/or from the definition of the data structure.

In the following, the functionality of embodiments will be explained. In an exemplary case of application, the sonication technology of a stadium is installed.

For example, four persons may be involved in installing the sonication technology, i.e., four sound engineers, for example. Each of the sound engineers may be responsible, e.g., for one wing of the stadium, e.g., one for the north wing, one for the south wing, one for the east wing and one for the west wing. Each of the sound engineers additionally carries an iPad®. The central mixing desk and the central sound system may then be controlled by means of this iPad®. A first person then starts to optimally adjust the sound for his/her position. Then the second person starts to adjust the sound. The second person also uses an iPad®. Then the third person and then the fourth person will proceed accordingly. The sound may also be adjusted simultaneously. In this manner each of the sound engineers can simultaneously hear which effects the adjustments made by the other sound engineers have. At the same time, the respective sound engineer who perceives a change can also undo said change or interfere otherwise. I.e., in this example the four sound engineers can achieve an optimum sonication situation all at the same time. This is achieved by controlling a central application with four different mobile devices. For implementing such applications, UI.FM is provided, which may be implemented, e.g., as a software framework. UI.FM designates the so-called user interface framework. This framework allows implementing such applications much faster and easier than has hitherto been possible.

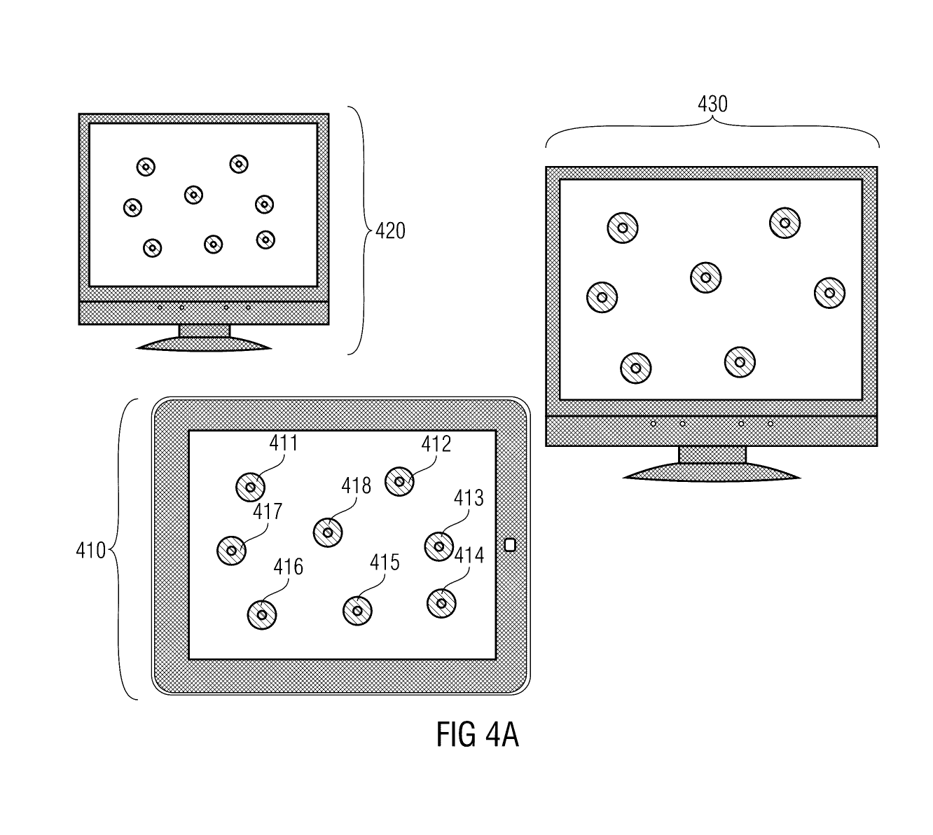

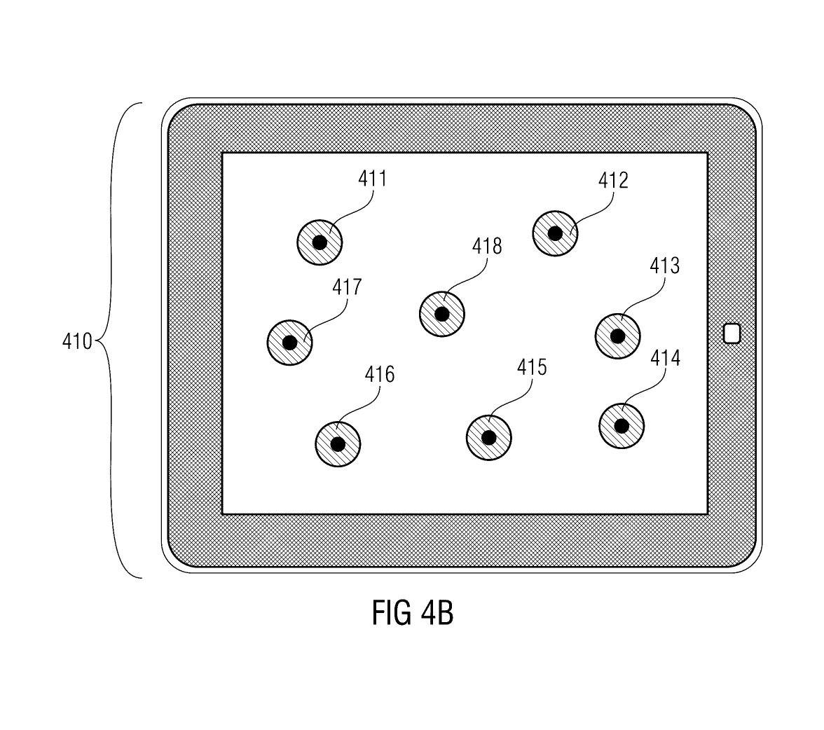

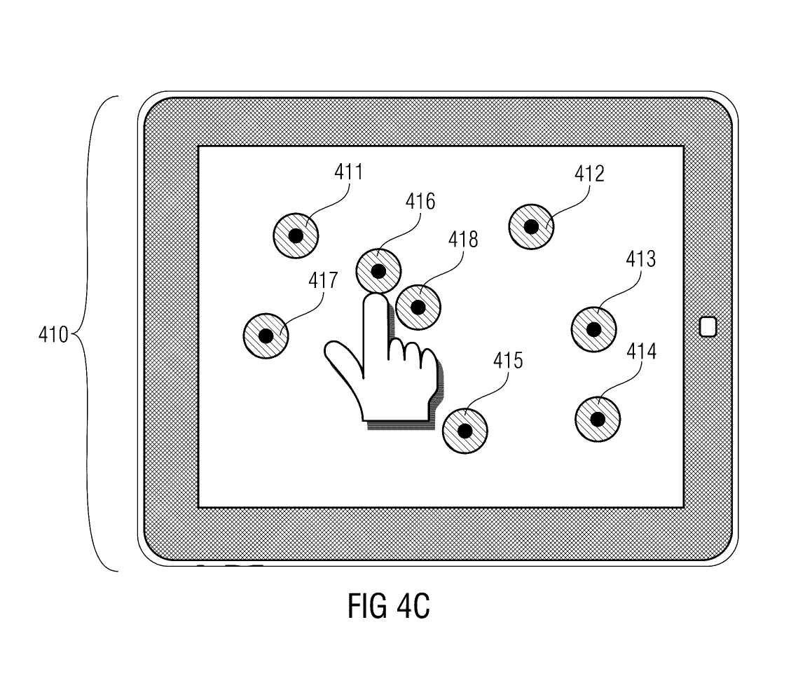

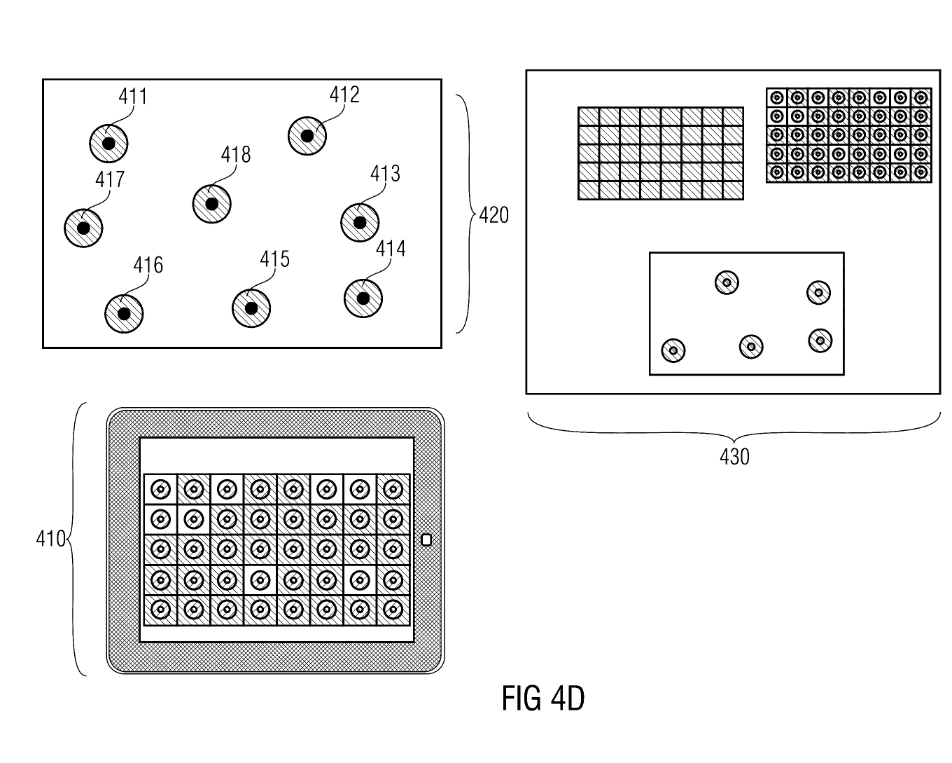

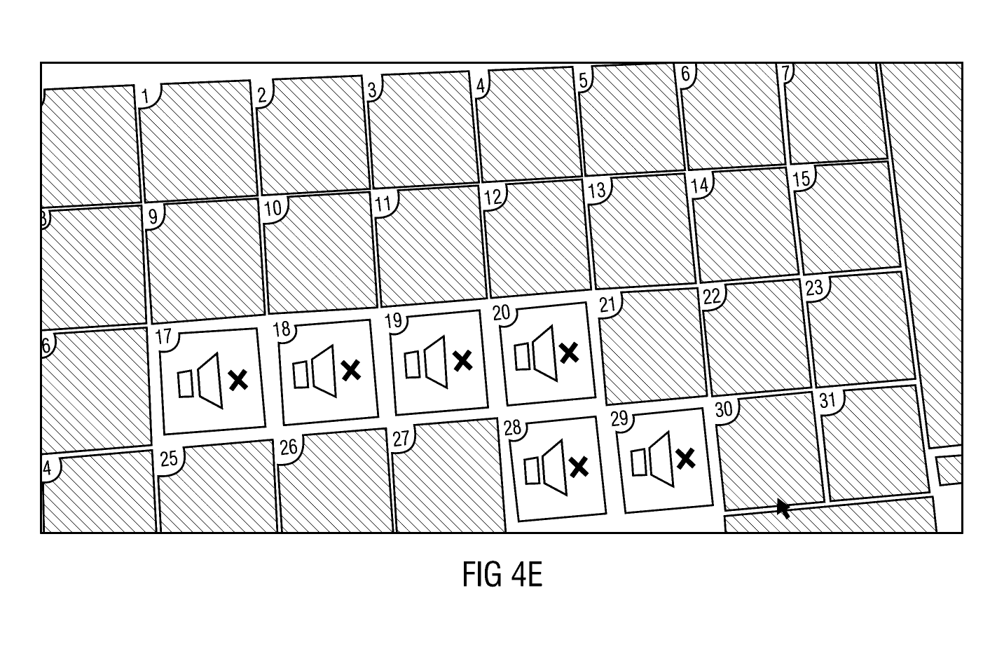

Any applications developed by UI.FM naturally exhibit multi-client ability. For example, FIG. 4a shows an application loaded onto an iPad® 410. On the client side, the application is also loaded onto a workplace PC 420. Moreover, the application is also loaded onto a further client, a further workplace PC 430. In total, the application is now present on three different clients 410, 420, 430.

If one considers FIG. 4b, one of the eight sources 411, 412, 413, 414, 415, 416, 417, 418, for example, can be touched and moved on this iPad®. Touching and moving of one of the sources, e.g., with a finger 419, is shown in FIG. 4c, for example. At the same time as a source is moved within a client 410, the source will also move in all of the other clients 420, 430.

Thus, one controls a source 416 by means of the finger 419 on a client 410, and said change in the source position of the source 416 will be transmitted directly to all of the other applications of the other clients 420, 430. Rather than by means of the finger 419, the source 416 may also be moved by means of a mouse, or of its pointer. Thus, the source may be moved on a PC by means of a mouse, for example, and the corresponding source on the other clients, e.g., on a different iPad®, will move along accordingly. I.e. several persons may simultaneously work with one application and change the parameters there, said changed parameters being transmitted to the other terminal devices.

Embodiments have the possibility of distributing applications to several terminal devices such that a workplace is expanded. For example, FIG. 4d shows the workplace PC 420 in the background, on the one hand, which has the eight different sources 411, 412, 413, 414, 415, 416, 417, 418 presented thereon.

At the same time, the workplace has been expanded by the iPad® 410 in the foreground. Both devices 410, 420 are separate from each other. Both devices 410, 420 have different client applications running thereon. The PC workplace 420 has a source positioning canvas installed thereon by means of which one can move the sources 411, 412, 413, 414, 415, 416, 417, 418. The iPad® 410 has a mute matrix installed thereon by means of which one can mute individual ones or all of the sources 411, 412, 413, 414, 415, 416, 417, 418.

Thus, the positioning canvas and the mute matrix may be simultaneously controlled with two hands. Thus, for example, one or more sources may be muted with the left hand, as can be seen in FIG. 4e, whereas the right hand may be used for controlling and positioning sources. Thus, one has expanded a PC workplace 420 by a second application running on a mobile terminal device 410, and both cooperate perfectly for an individual user.

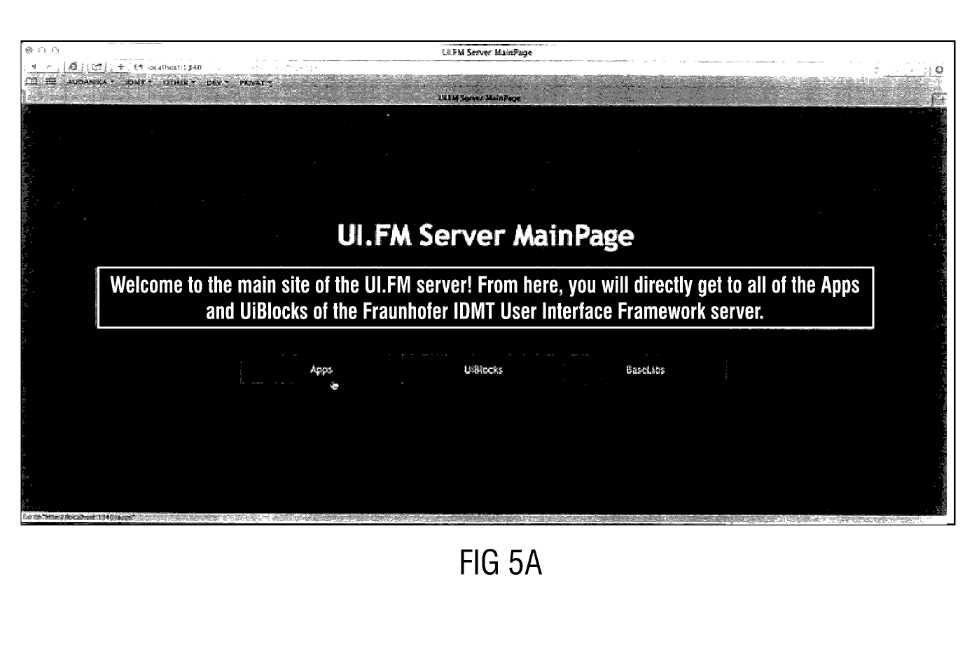

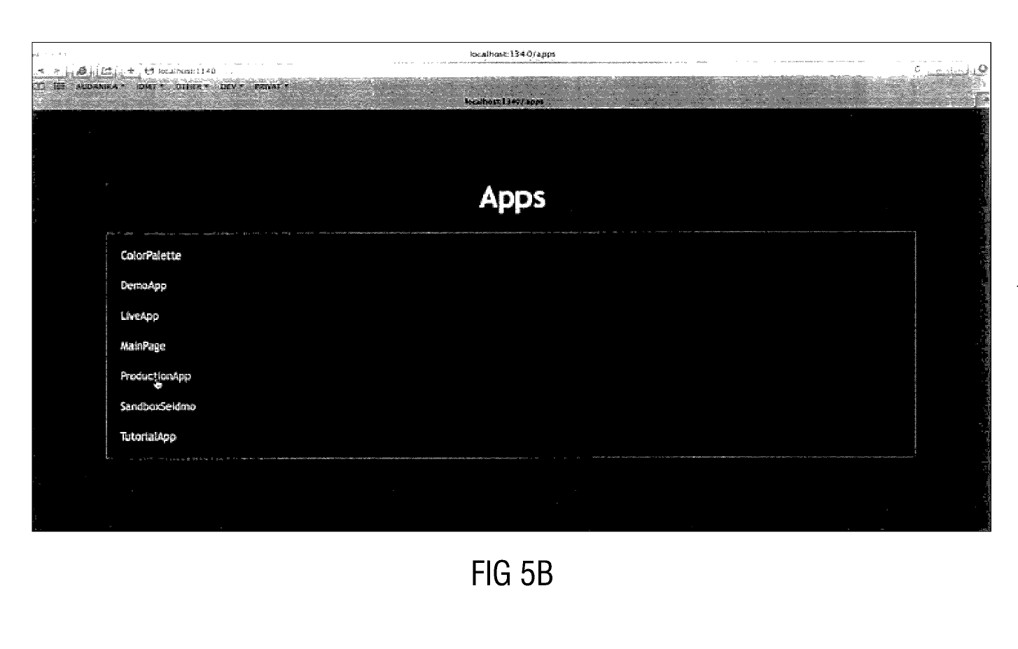

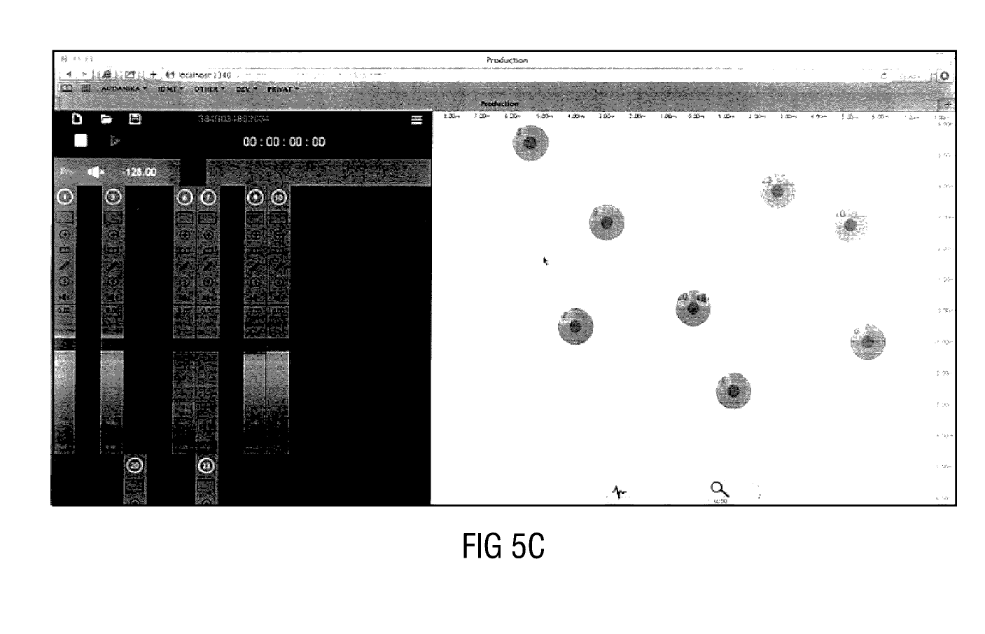

In accordance with embodiments, UI.FM is web-based. FIG. 5a shows the server side of UI.FM in accordance with an embodiment. After clicking on “Apps” one gets to the App site presented in FIG. 5b. For example, the application “ProductionApp” running on the UI.FM server may be clicked on, as a result of which the “ProductionApp” is opened, as is shown in FIG. 5c. Now one can work with this application (“App”=application).

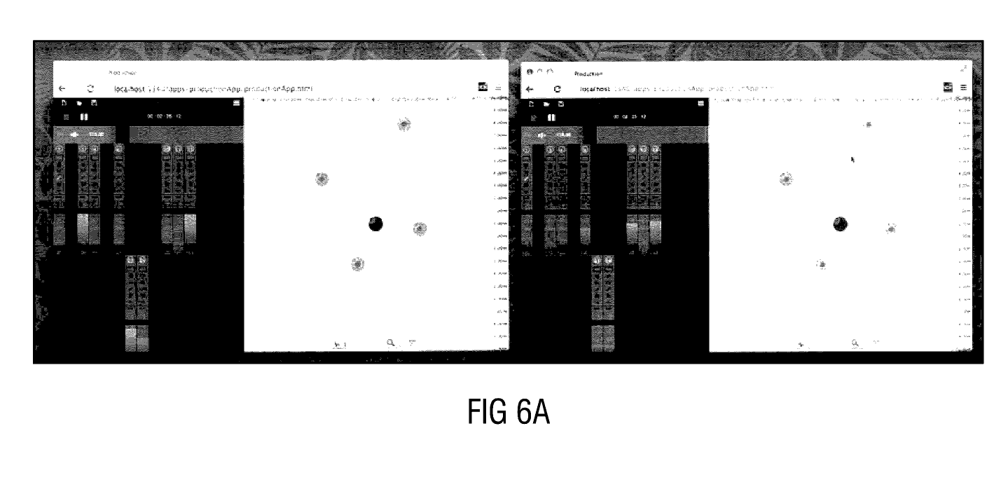

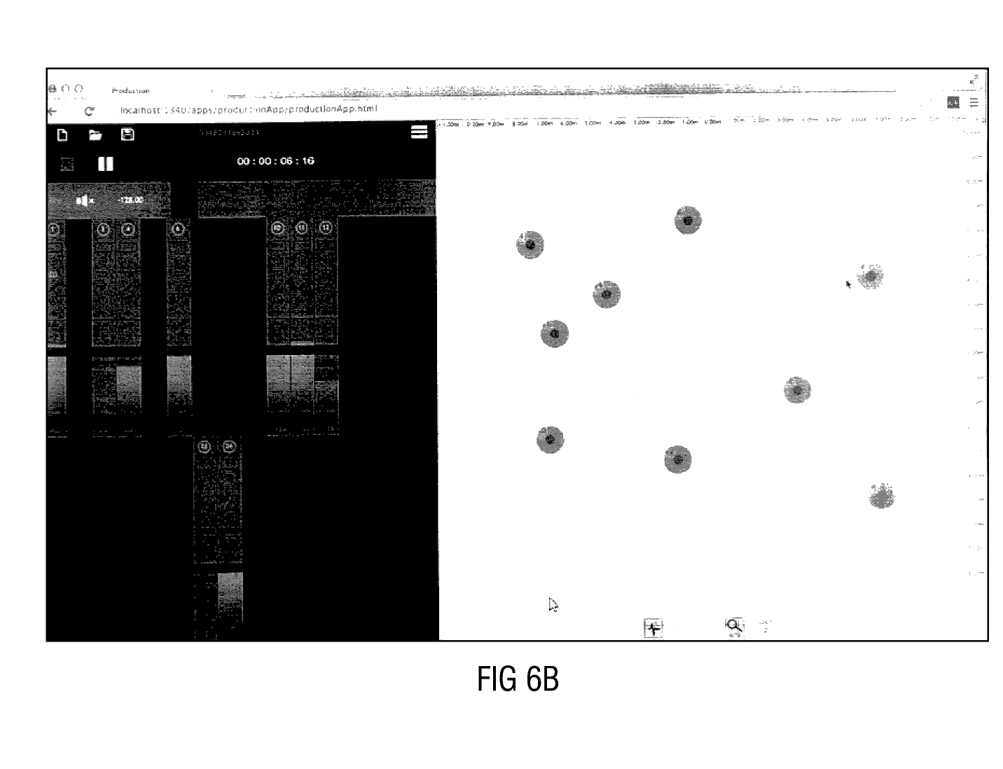

UI.FM runs with low delay. Anything that is done within an application on a client is transmitted to the corresponding application on the other client as fast as possible. Thus, real time data can be indicated in the web browser. For example, up to 32 sources can be displayed and controlled in FIG. 6a. The levels of said up to 32 sources are updated with 25 pictures per second. In the same way, the up to 32 source positions are also updated, namely within a very short time period.

In one embodiment, the change of an attribute of one of the nodes of the data model can be recorded. Thus, all of the parameters are fundamentally automatable in UI.FM. For example, a scenario is shown in FIG. 6b wherein one can start a recording, move a source, stop the recording and then start the recording, so that the source movement performed before is now played back. Thus, embodiments enable recording of parameters.

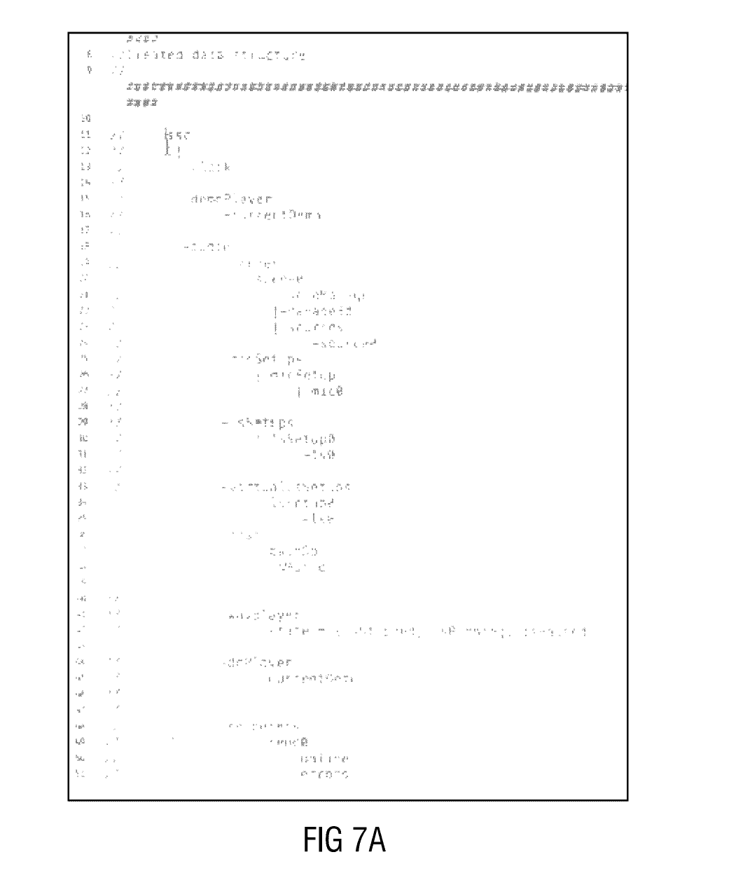

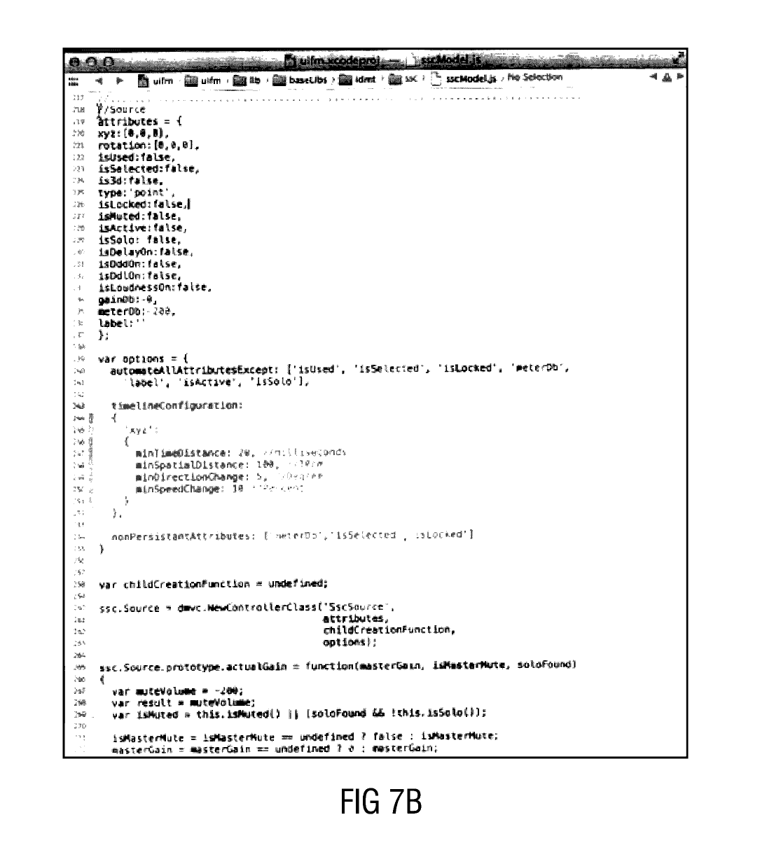

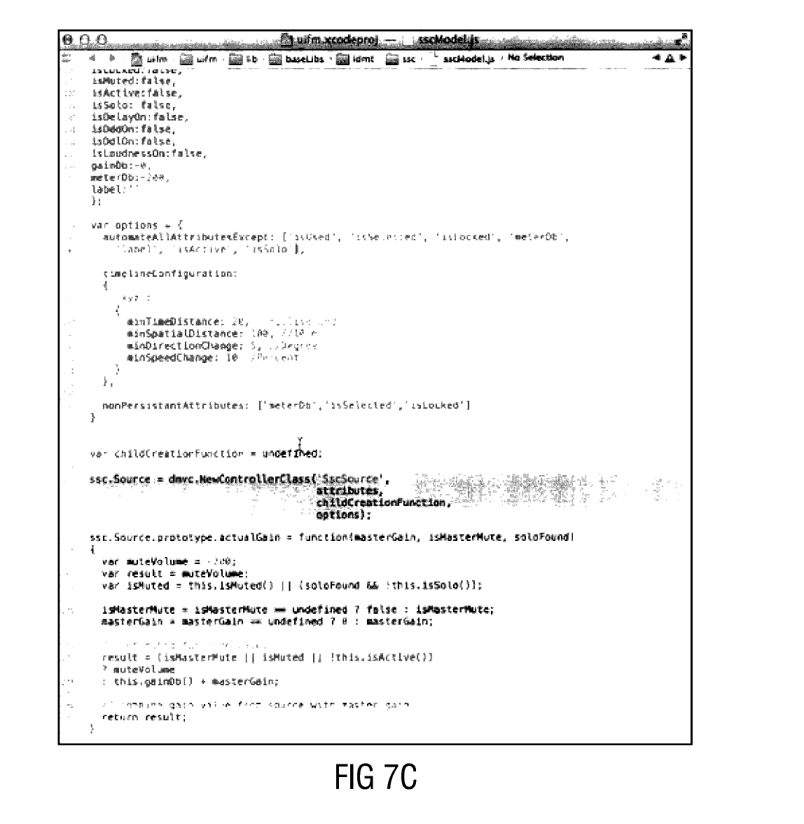

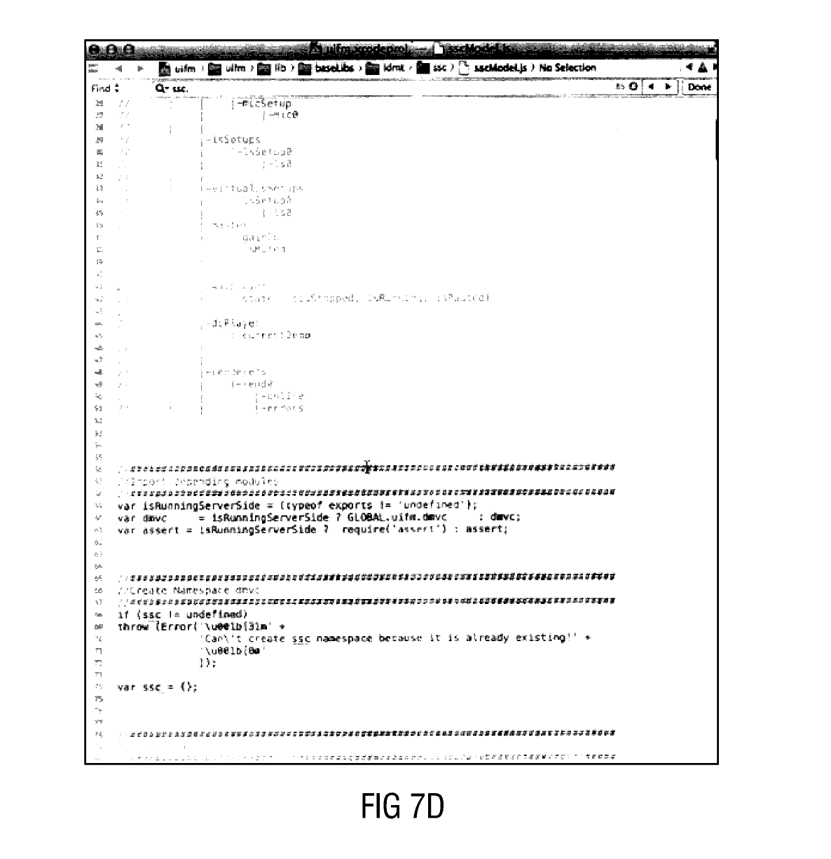

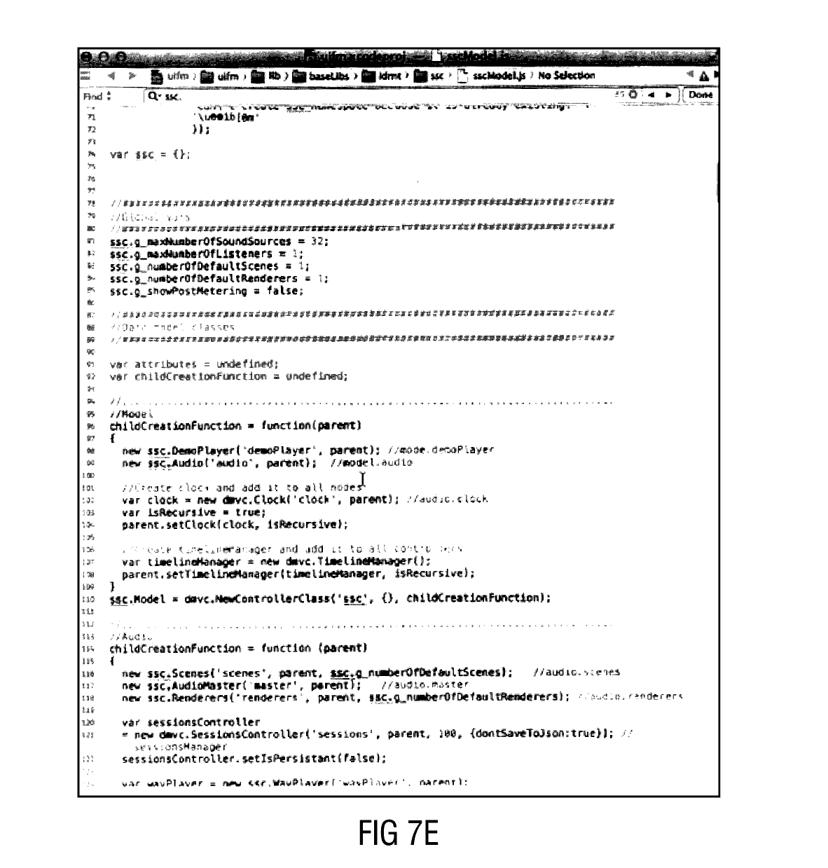

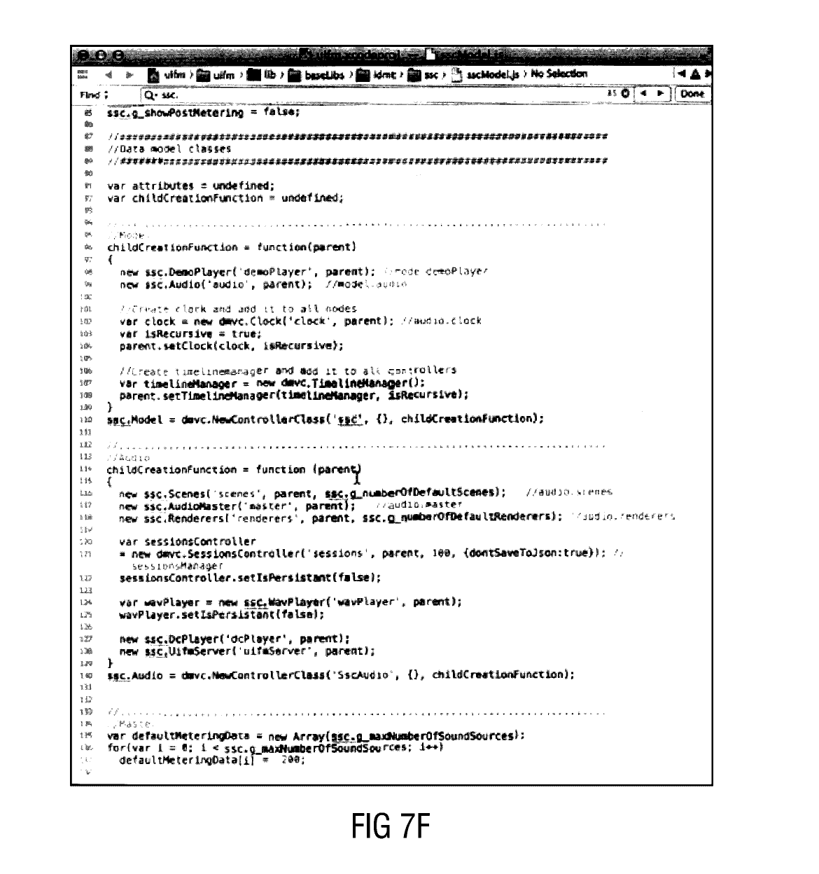

In embodiments of UI.FM the application developer can define a graph-shaped, e.g., tree-shaped, data model as is shown in FIG. 7a, for example.

FIG. 7a shows an exemplary data model of an exemplary application. The root node is not referred to as “root” but as “ssc” in FIG. 7a; however, nothing is changed in terms of its significance as a root node. Different subnodes exist, such as “clock”, “demoPlayer” and “audio”. The node in “audio” has various subnodes, e.g., the subnode “scenes”, existing below it. The node “scenes” includes the subnode “scene0”. The subnode “scene0” in turn includes the subnodes “soloManager”, “manage3d” and “sources”. The source “src0” is located below the node “sources”. Moreover, the node “audio” has the subnodes “micSetups”, “IsSetups” and “virtualLsSetups” located below it.

In total, the data occurring within the system are structured in a graph-shaped, e.g., tree-shaped, manner.

FIGS. 7b and 7c show an example of how a data model is formulated quite specifically. Specifically, this is about the definition of a source. Here, one initially defines the attributes of the object, within a source e.g. the position, the rotation, whether it is used (isUsed), whether the source is selected (isSelected), whether the source is locked (isLocked), whether the source is muted (isMuted), or, e.g., whether the source is a 3D source, etc.

Each of said attributes has a standard value associated with it. The standard value simultaneously is used for determining the data type of the attribute. In addition, there are various options which specify which of said attributes are to be automated (“automate all attributes except”).

Moreover, a definition is given of what the timeline for the automation is to be like (timeline configuration) and how closely adjacent display points, i.e. key frames, are intended to be. Moreover, it should be possible, for example, to indicate spatial neighborhoods as well as changes of direction. Optimization of the data recording/the automation described above is achieved. Moreover, it can also be described that not all of the attributes, but only specific ones, are stored directly in a file. There are thus most varied combination options.

A new controller subunit for a new node may be generated by calling up NewControllerClass within the data model. The name, the attributes, the childCreationFunction and options are handed over to this call. In this manner, the new node is defined.

In addition, the individual nodes are to be brought into a graph-shaped, e.g., tree-shaped, hierarchy. The tree-shaped hierarchy was already graphically depicted in FIG. 7a. Thus, the “source0” source is located within a “sources” container, which again is located within a “scene0” container, which in turn is located within a “scenes” container.

Various programming commands, which are illustrated in FIGS. 7d, 7e, 7f, exist for designing the data model outlined in FIG. 7a. On the one hand, the nodes are to be defined and in addition, the attributes of the nodes are to be defined, and the nodes are to be assigned to a parent node via predefined commands. In this manner a corresponding hierarchy may be established.

In accordance with embodiments, UI.FM is capable of deriving and automatically generating, for example, a series of useful tools from the graph-shaped, e.g., tree-shaped, data structure. Said software tools, e.g., software development tools, will be described in the following.

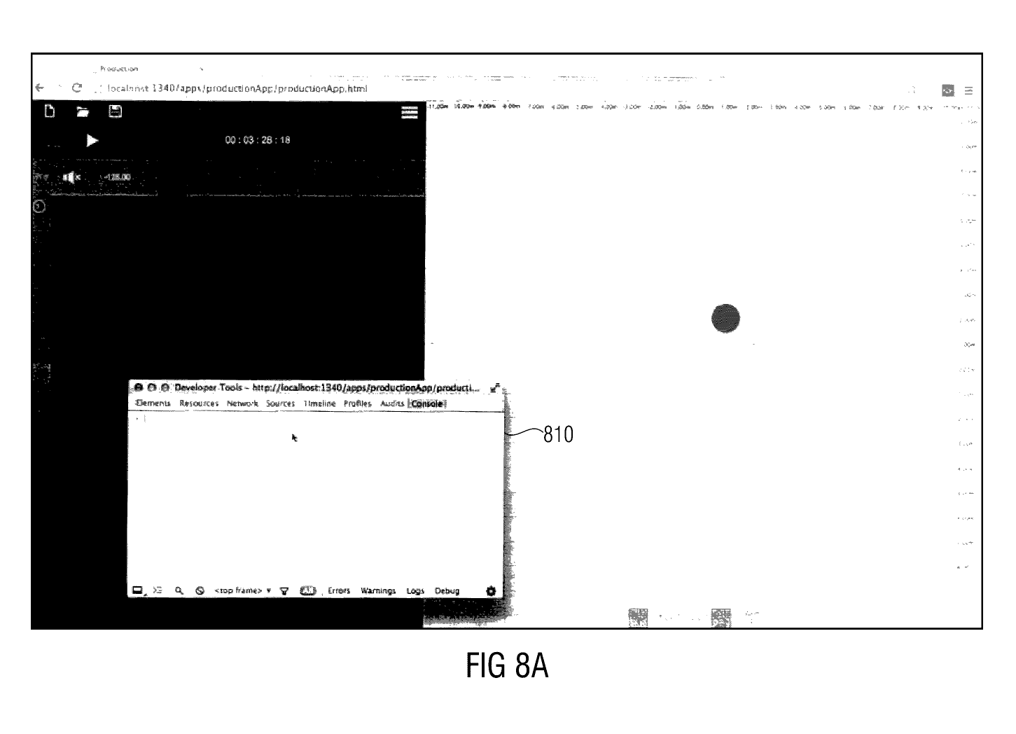

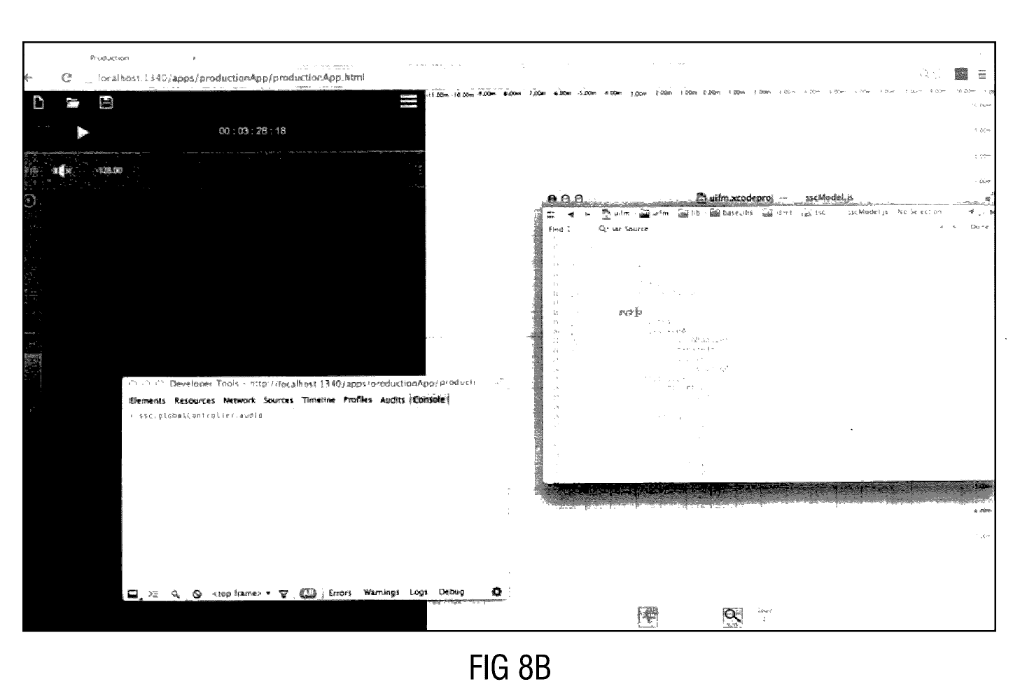

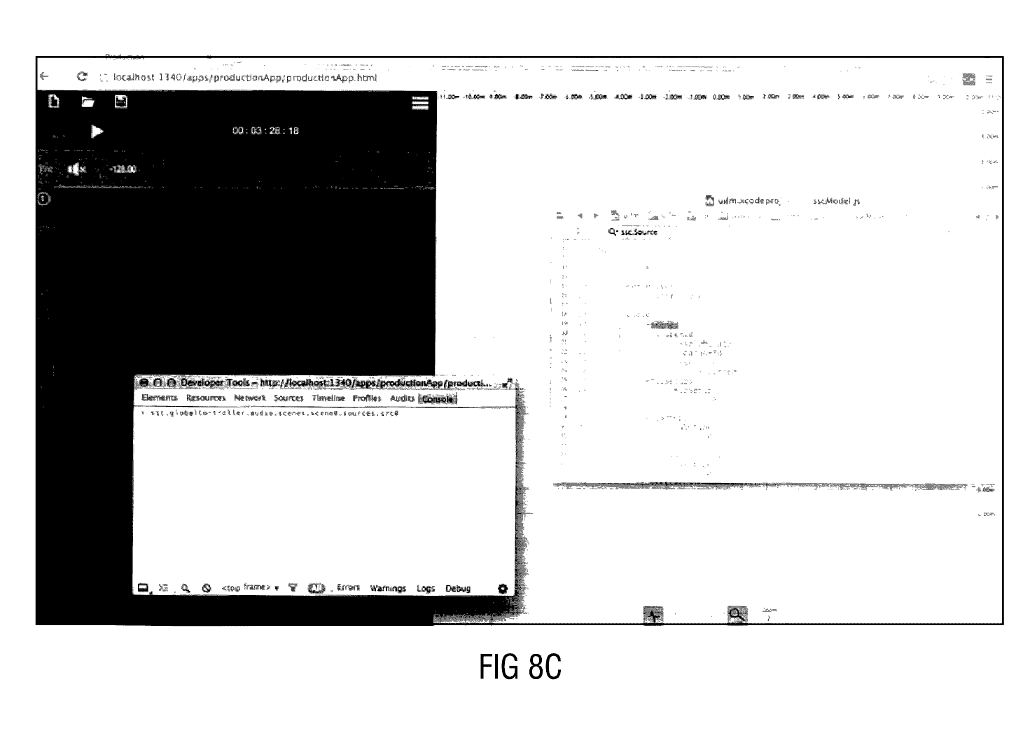

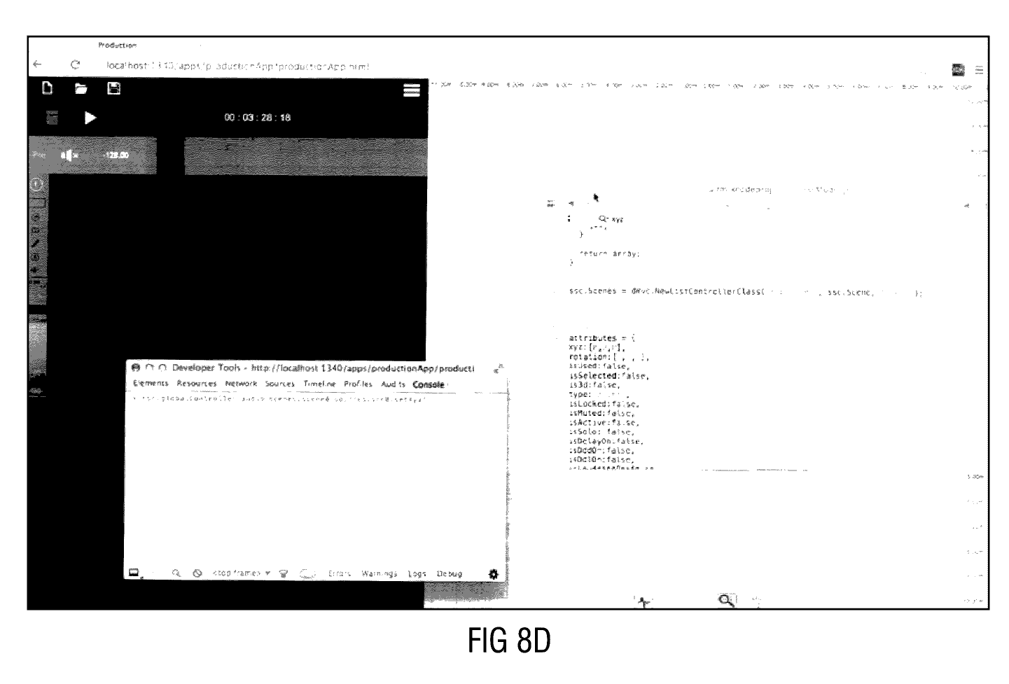

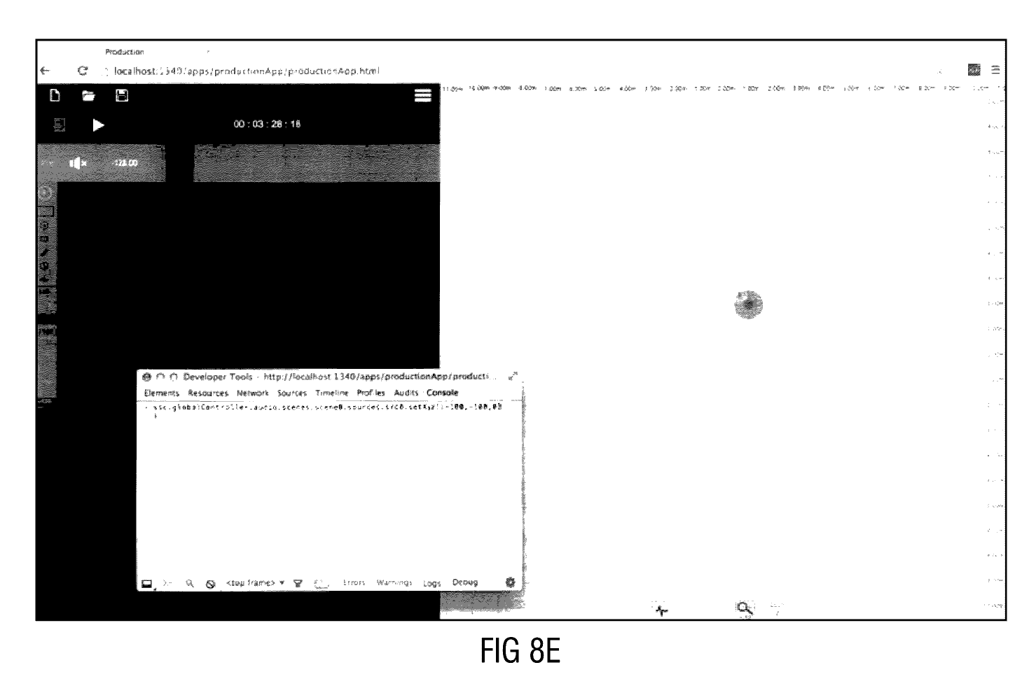

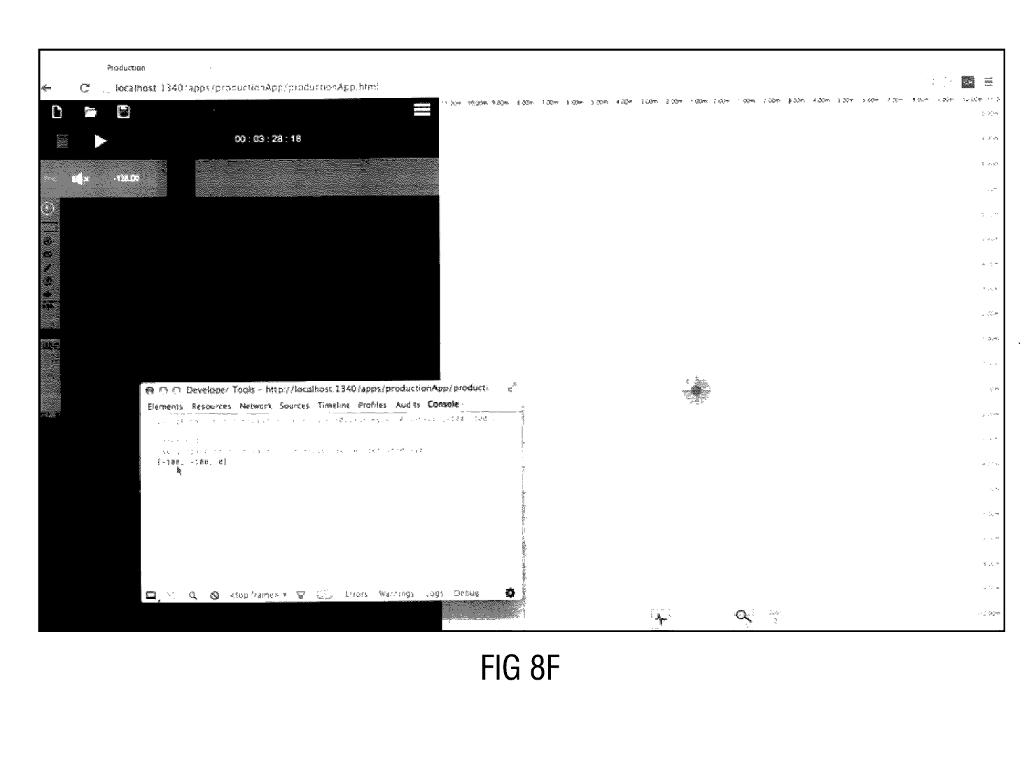

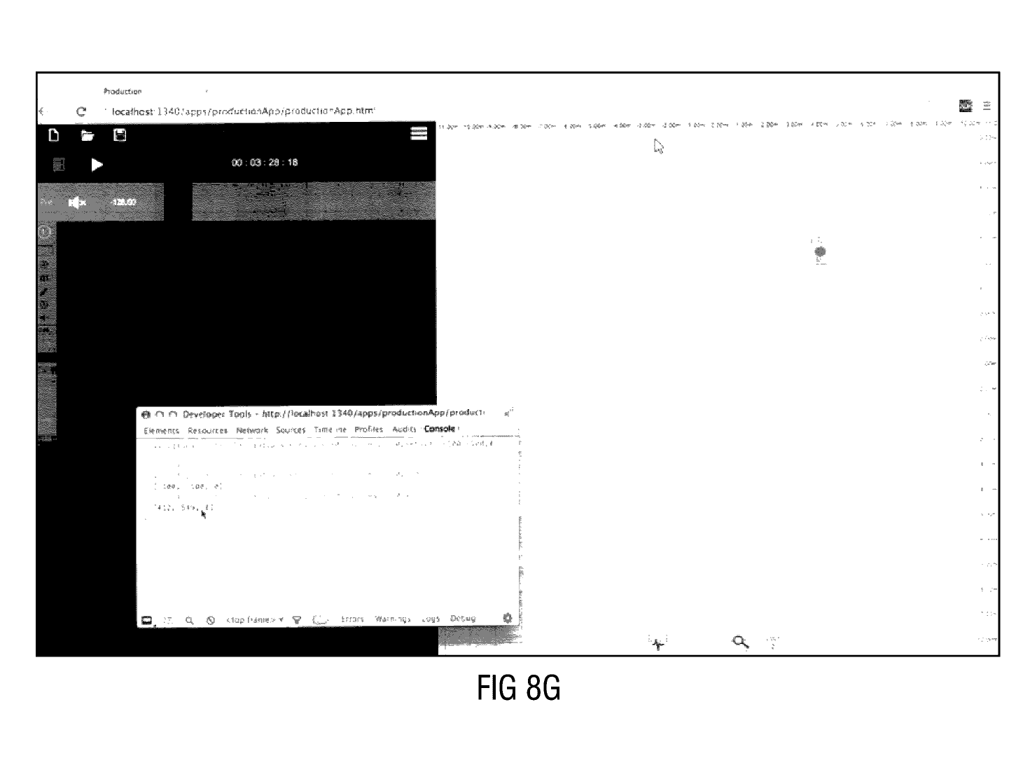

A first tool implements automatic generation of programming commands for achieving nodes within the data model. Thus, UI.FM automatically generates programming commands from the previously defined tree hierarchy. FIG. 8a shows an example thereof, wherein a JavaScript console 810 is opened. Such a JavaScript console 810 is located in browsers, for example, such as Chrome® and Firefox®. It is via this console that the data model loaded within the browser can be accessed.

If, as is shown in FIG. 8b, e.g., the sequence of nodes called “ssc.globalController.audio” is entered into the JavaScript console 810, one will address the “audio” node generated previously. The “audio” node has a “scenes” subnode existing underneath it. Said “scenes” subnode may be accessed by adding the name “scenes” after “audio”. Only the first two letters of “scenes” are entered. “sc” will then automatically be supplemented to read “scenes”. This is due to the fact that the correct programming command was automatically attached in a live and dynamic manner from the previously defined, e.g., tree-shaped, hierarchy. Next, the node name “scene0” is added, then the “sources” subnode is addressed, and finally the “src0” source. When entering the respective first letters of the nodes names, the system in each case offers possible supplements since the system already knows the corresponding subnodes that come into question. The complete path to “src0” is shown in FIG. 8c.

Additionally, FIG. 8d specifies which property of the source is to be changed, by the function call “setXyz” there. The command “setXyz” was generated automatically. However, in the data definition, merely “xyz: [0,0,0]” was entered, as shown in FIG. 8d. Thus, what was defined is merely the fact that an attribute is to exist that is called xyz and that has the standard value [0,0,0]. From this line, UI.FM has automatically generated the command “setXyz( )”.

FIG. 8e shows the command for shifting the source to the position [−100, −100, 0]. If the command is sent by pressing Enter, the source will automatically be shifted, as shown in FIG. 8f. This is due to the fact, for example, that an event (message) was generated within the automatically generated setXyz function. The source representation has subscribed to this message and subsequently was able to change its position.

Thus, the application developer can simply intuitively access the integral parts, i.e., the nodes, of the data model. In addition to the setXyz( )function, there is also automatically a function for reading, which is generated automatically. This function is shown in FIG. 8f and designated by “xyz( )”. If the corresponding command “xyz( )” is sent, the current position, “[−100, −100, 0]” will be output. If one shifts the position as shown in FIG. 8g and if one calls up once again the function for displaying the current position, the current position of the source will be output.

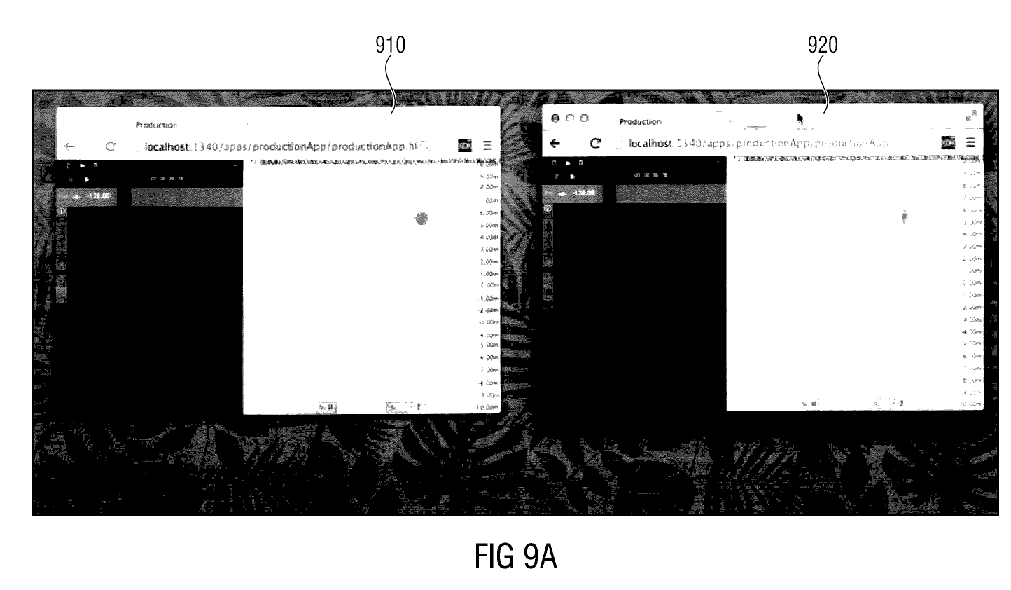

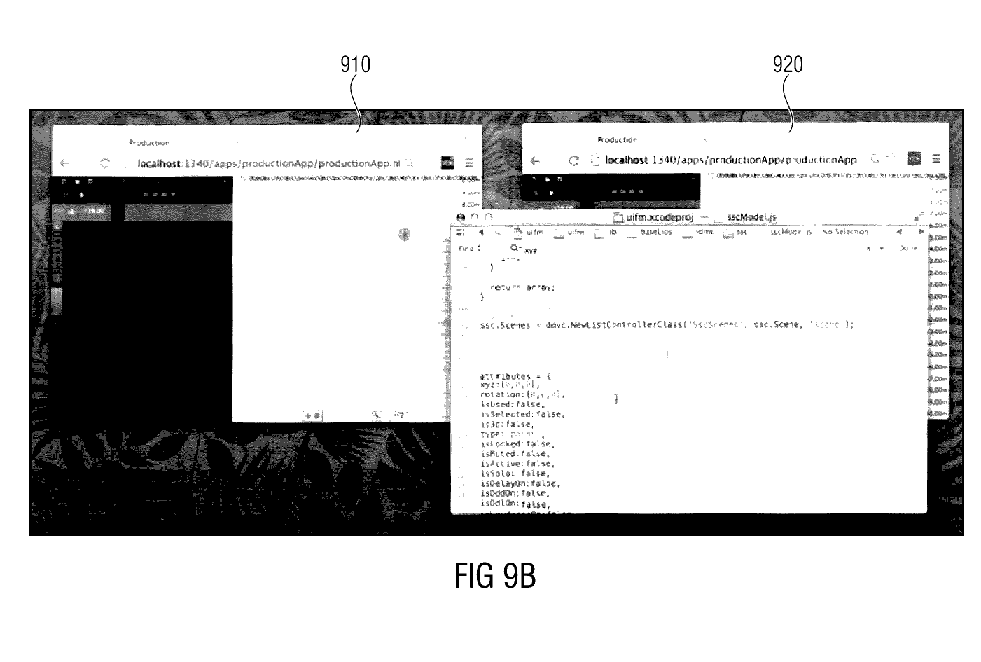

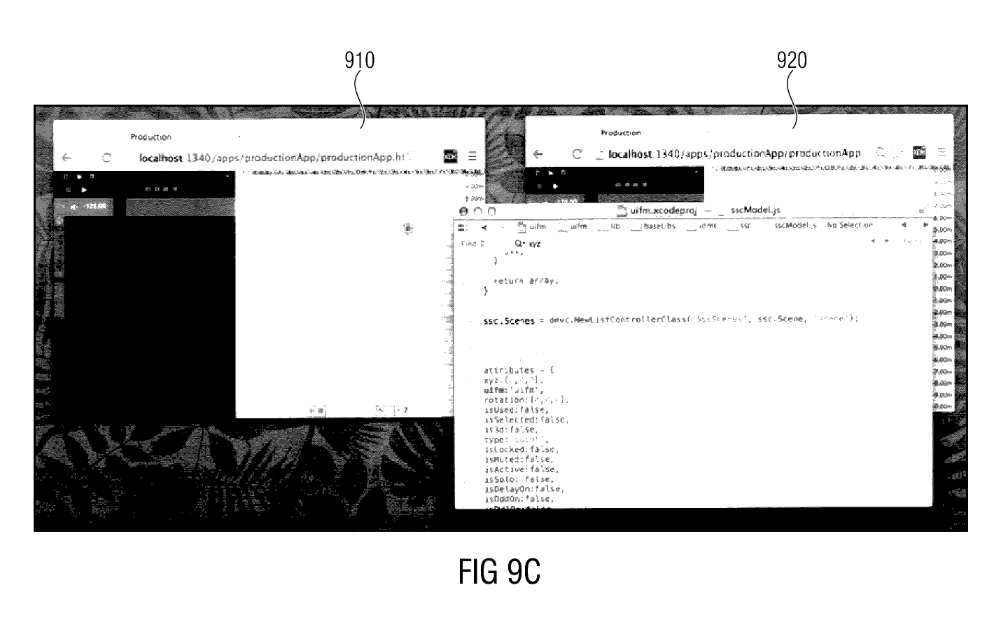

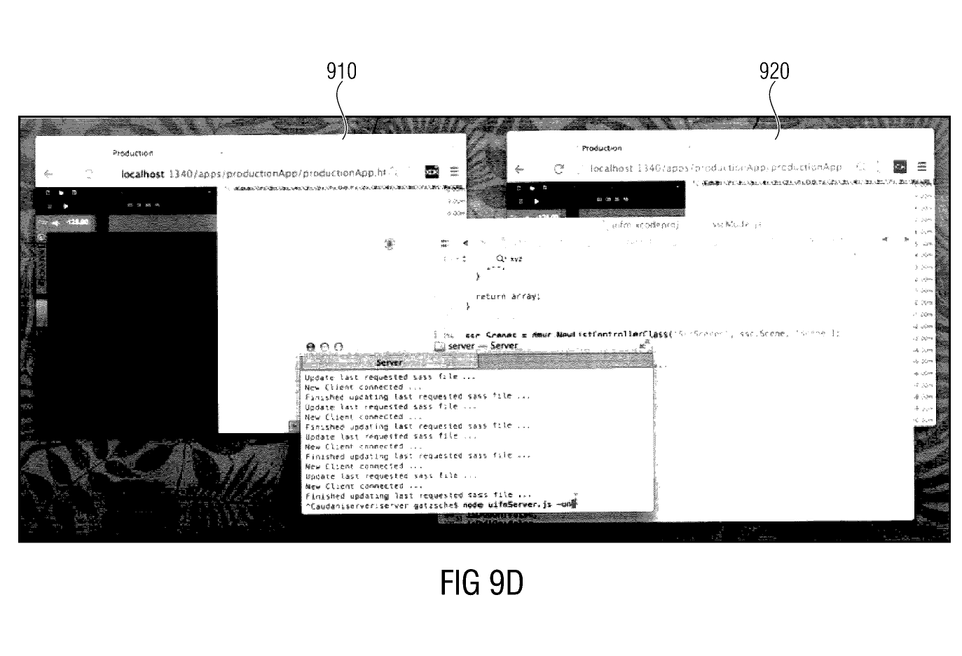

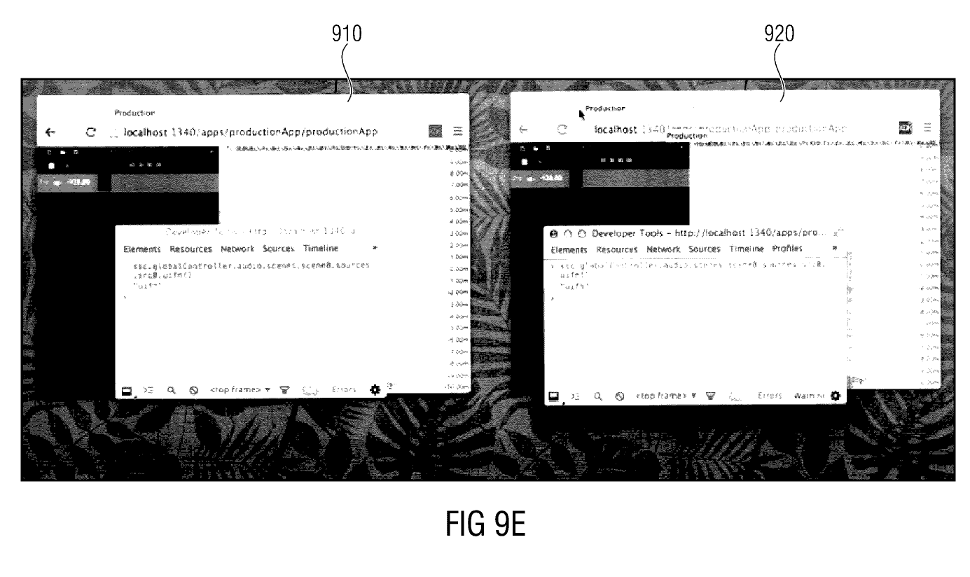

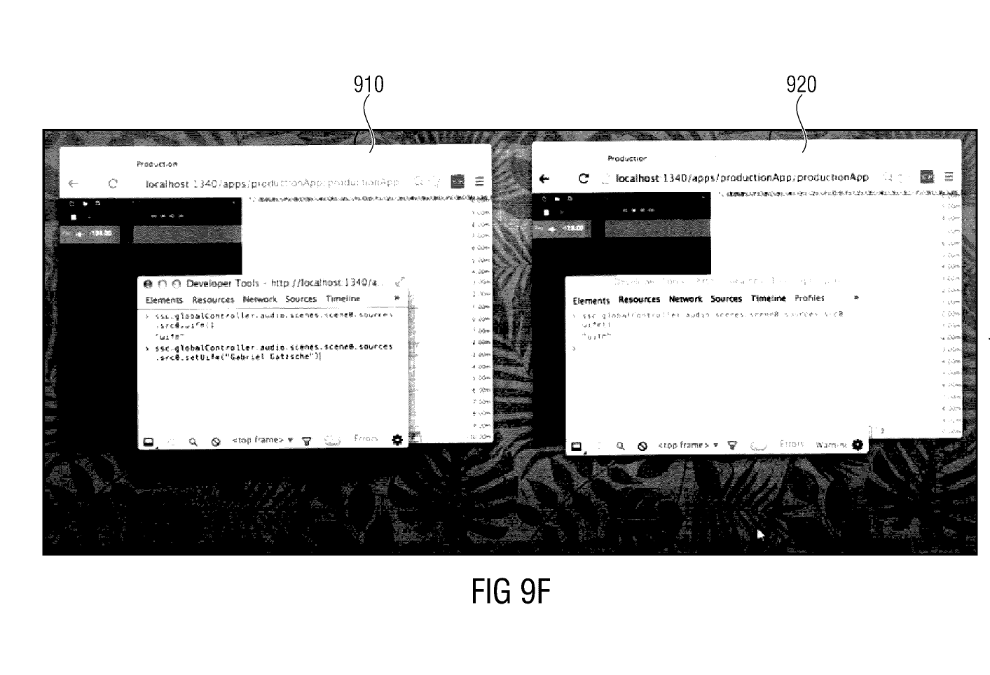

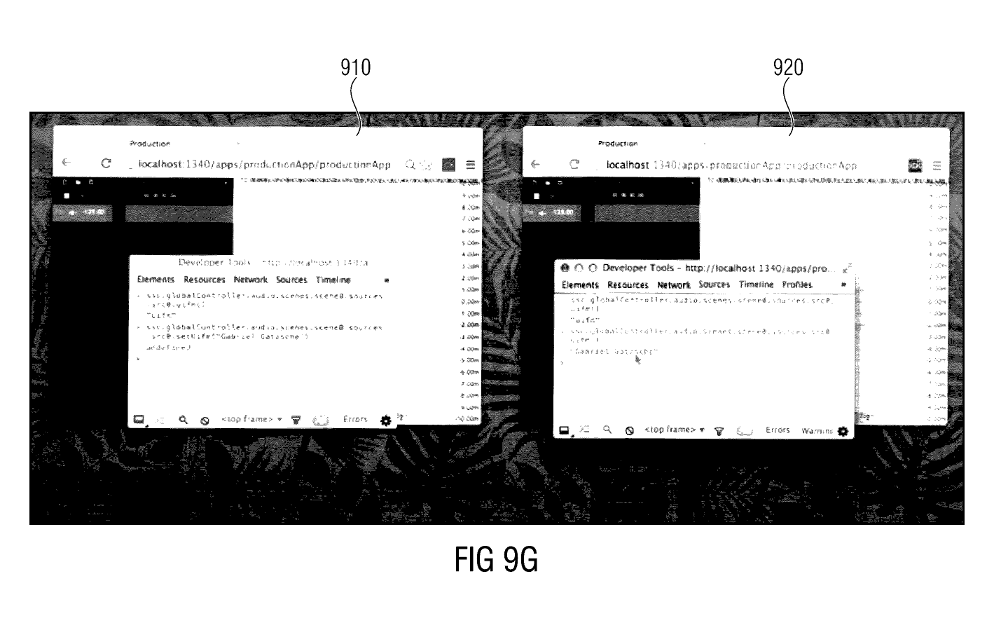

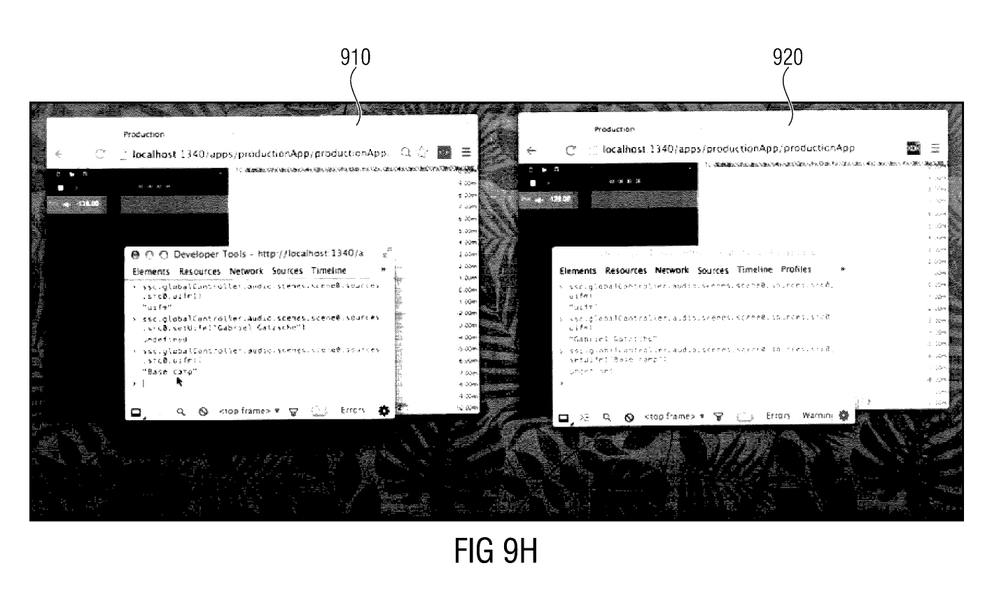

In accordance with embodiments, UI.FM is capable of automatically generating the synchronization code so as to transmit attributes or properties from a source A on the client 1 to the same source A on the client 2. FIG. 9a shows a program that was started twice as two applications 910, 920.

A new attribute can be added fast and easily. For example, FIG. 9b shows, in a further window, the data model of a source, said data model already having been described above. As shown in FIG. 9c, a further attribute may now easily be added.

In FIG. 9c, the attribute “uifm” having the value ‘uifm’ is added. The attribute thus has a string as its value. By merely inserting a line underneath “attributes”, a new attribute has been inserted.

In order for such a new definition that has been performed to have an effect it may be useful, for example, to restart the server 300 as shown in FIG. 9d. Thus, the UI.FM server 300 can be restarted by means of a server command line. Following the restart of the server 300, both applications 910, 920 will also be restarted.

FIG. 9e shows that this newly inserted “uifm” attribute can be queried via the automatically generated “uifm( )” command in both applications 910, 920 and provides the “uifm” data string as the return value. This works both within the client and within the server.

It is also possible to change the value of the uifm attribute by an automatically generated “setUifm( )”function. This is shown in FIGS. 9f and 9g. The performed update of the uifm attribute in the first application 910 is automatically transmitted to the second application 920 on the right-hand side of FIG. 9g. Querying the uifm attribute by means of the automatically generated uifm( ) function will provide the updated string “Gabriel Gatzsche” in the right-side application 920 of FIG. 9g as well.

Likewise, the value of the uifm attribute may also be reset, conversely, in the right-hand side application, e.g., to “Base camp”, as shown in FIG. 9h. Such an update has an immediate and instant effect on the left-hand side application 910 in FIG. 9h. Thus, UI.FM allows fast and easy expansion of the data model and allows fast and easy generation of synchronization codes.

UI.FM automatically generates codes with which connected observers can let themselves be informed when a value of the data model changes (see, e.g., publisher-observer, a design pattern). The observer referred to is not a human observer but a program module that subscribes to a change message and automatically receives same as soon as the data model changes.

In accordance with one embodiment, change monitoring may be installed, e.g., for one of the attributes of one of the nodes of the data model upon a user input. For example, an alert is output when a value of one of the attributes for which change monitoring has been installed changes. Outputting an alert is only an example. Another possibility is for the title bar of the browser to be updated, for example, or the like.

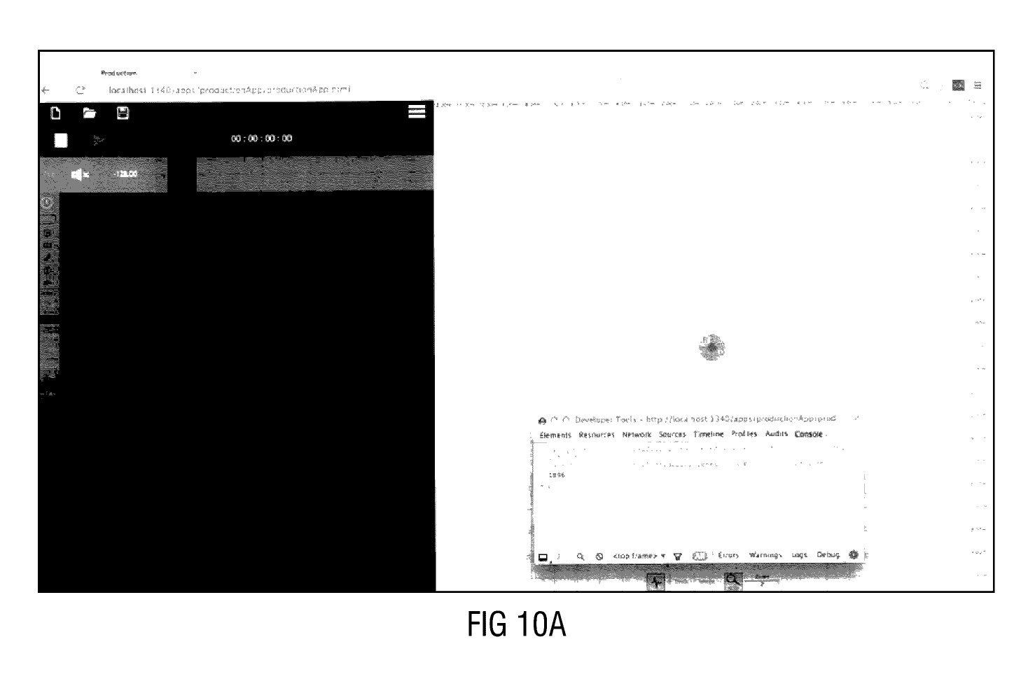

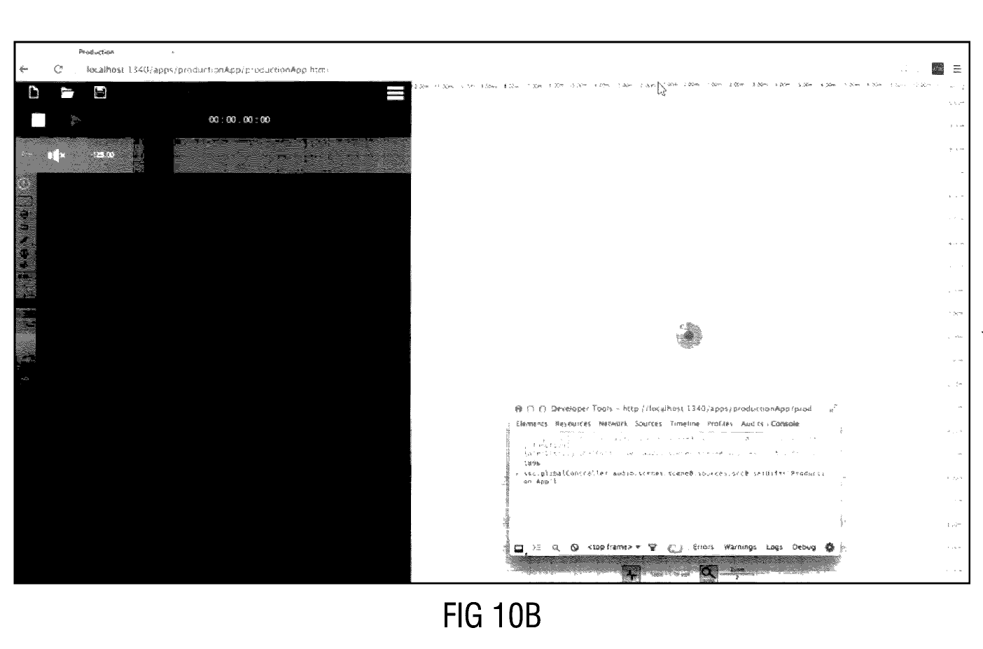

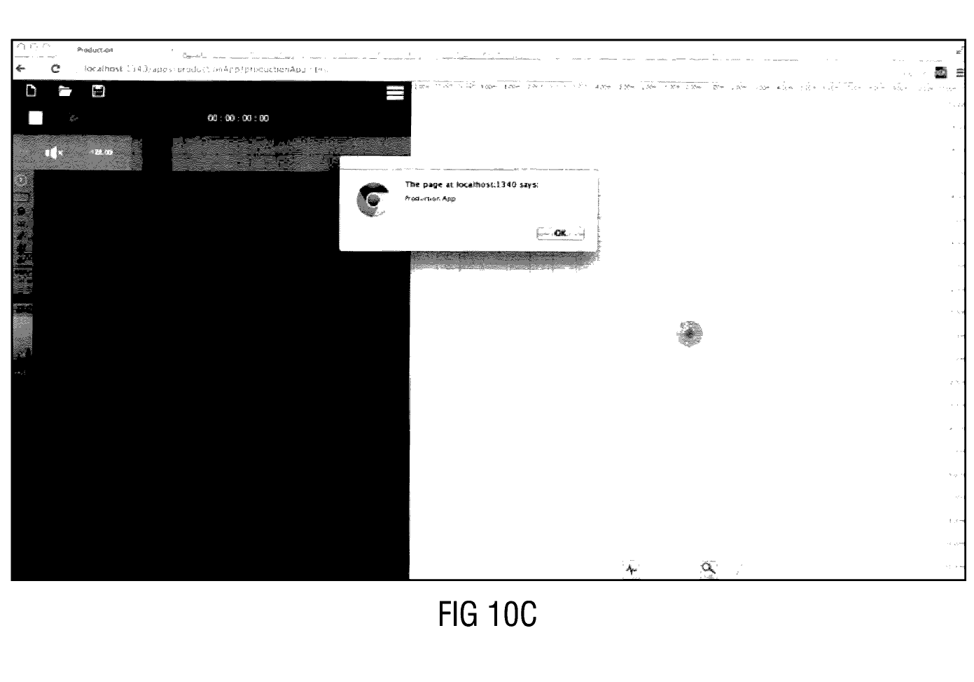

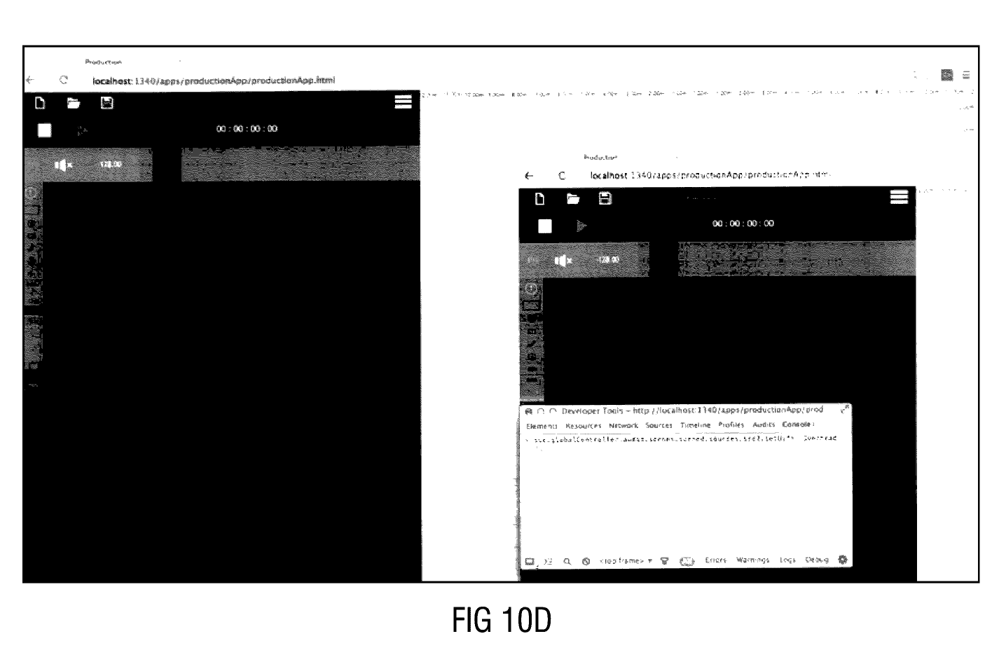

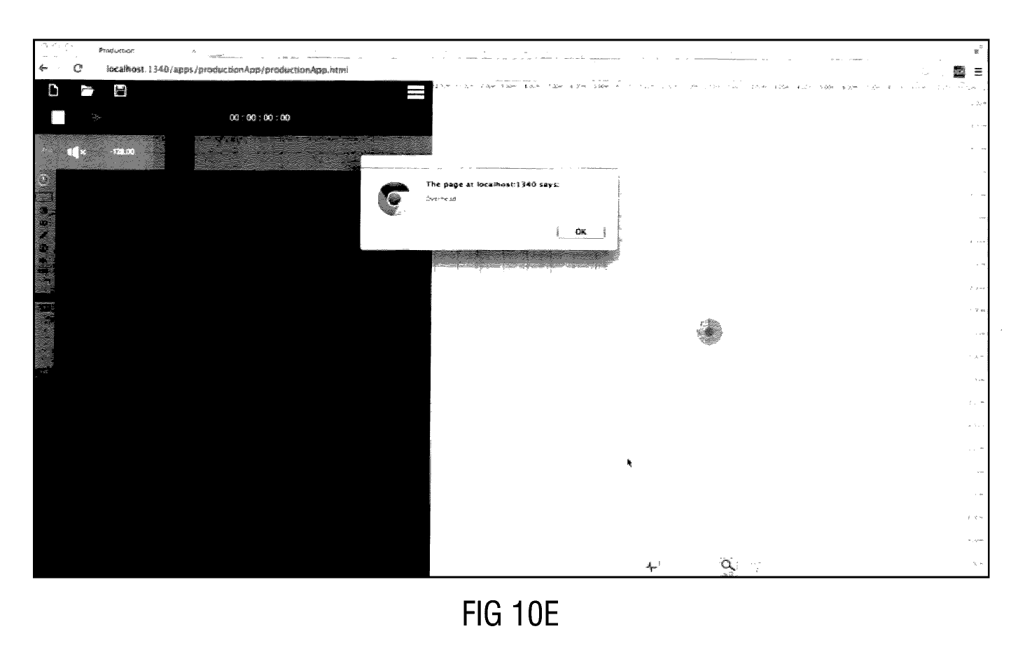

This is explained with reference to FIG. 10a, where change monitoring is installed. By the command “on(‘change[uifm]’, function( )” entered in the console, the system is caused to call up the subsequently defined function when the value of uifm changes. The function( ) definition of FIG. 10a defines that in this case, an alert is to be output which shows the value of the property uifm. If one presses Enter in the console, the observer thus defined will be registered.

In FIG. 10b, the value of uifm in ‘production app’ is changed. As shown in FIG. 10c, an alert then appears which outputs the new value of uifm, namely “production app”. This will also work if a second client is opened.

FIG. 10d shows opening of a second client. The value of uifm is changed by the “setUifm” function within a console. Even though the value of uifm has been changed in the second client, the alert stating that the value of uifm has changed to “overhead” is also output in the first client, as can be seen in FIG. 10e.

In detail, the new value of uifm was transmitted from the second client to the server, and from the server, the value was transmitted to the first client, there the value of was updated accordingly, and the observer was informed, which has resulted in the alert being output, as shown in FIG. 10e.

By means of UI.FM it is also very easy to record time line data. As described above, the attribute uifm has been added to the data model. In one embodiment, code is automatically generated, on account of this attribute, so as to record time line data. For example, various changes of the value uifm can be recorded over time. Pressing, e.g., a play key may ensure that the time starts running. If the value of uifm is initially set to “Friday”, then to “Saturday”, then to “Sunday”, said data changes will be recorded behavior in their chronological order within the waveform.

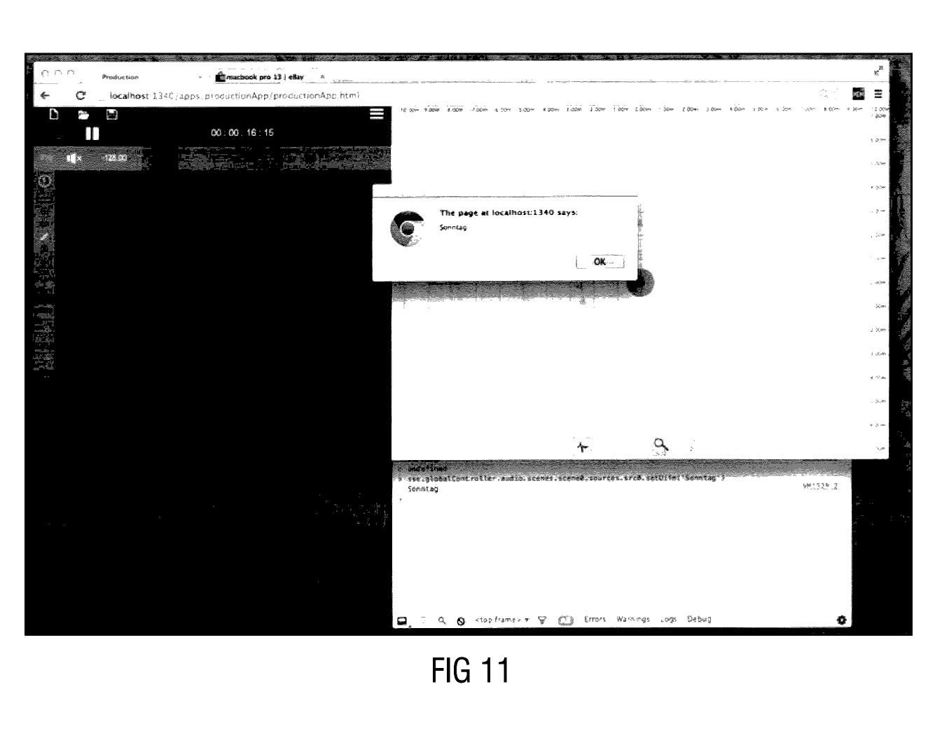

For example, if one activates the reading mode/reproduction mode, the previously recorded data will once again be written into the data model from the time line via the writing function. Connected observers (views) are informed and automatically output alerts, for example, specifically at that point in time in the reproduction, in each case, at which also the value has been changed during the pickup mode. For example, in FIG. 11, the alert “Sunday” is output at that point in time at which the value “Sunday” is also changed in the rerun of the recording. Thus, embodiments enable pickups of inputs that are reproduced in a temporally correct manner by the system when they are reproduced and which, e.g., output alerts in a temporally correct manner in accordance with the pickup.

Even though some aspects have been described within the context of an apparatus, it is understood that said aspects also represent a description of the corresponding method, so that a block or a structural component of an apparatus is also to be understood as a corresponding method step or as a feature of a method step. By analogy therewith, aspects that have been described in connection with or as a method step also represent a description of a corresponding block or detail or feature of a corresponding apparatus. Some or all of the method steps may be performed by a hardware apparatus (or while using a hardware apparatus), such as a microprocessor, a programmable computer or an electronic circuit. In some embodiments, some or several of the most important method steps may be performed by such an apparatus.

Depending on specific implementation requirements, embodiments of the invention may be implemented in hardware or in software. Implementation may be effected while using a digital storage medium, for example a floppy disc, a DVD, a Blu-ray disc, a CD, a ROM, a PROM, an EPROM, an EEPROM or a FLASH memory, a hard disc or any other magnetic or optical memory which has electronically readable control signals stored thereon which may cooperate, or cooperate, with a programmable computer system such that the respective method is performed. This is why the digital storage medium may be computer-readable.

Some embodiments in accordance with the invention thus comprise a data carrier which comprises electronically readable control signals that are capable of cooperating with a programmable computer system such that any of the methods described herein is performed.

Generally, embodiments of the present invention may be implemented as a computer program product having a program code, the program code being effective to perform any of the methods when the computer program product runs on a computer.

The program code may also be stored on a machine-readable carrier, for example.

Other embodiments include the computer program for performing any of the methods described herein, said computer program being stored on a machine-readable carrier. In other words, an embodiment of the inventive method thus is a computer program which has a program code for performing any of the methods described herein, when the computer program runs on a computer.

A further embodiment of the inventive methods thus is a data carrier (or a digital storage medium or a computer-readable medium) on which the computer program for performing any of the methods described herein is recorded.

A further embodiment of the inventive method thus is a data stream or a sequence of signals representing the computer program for performing any of the methods described herein. The data stream or the sequence of signals may be configured, for example, to be transferred via a data communication link, for example via the internet.

A further embodiment includes a processing means, for example a computer or a programmable logic device, configured or adapted to perform any of the methods described herein.

A further embodiment includes a computer on which the computer program for performing any of the methods described herein is installed.

A further embodiment in accordance with the invention includes an apparatus or a system configured to transmit a computer program for performing at least one of the methods described herein to a receiver. The transmission may be electronic or optical, for example. The receiver may be a computer, a mobile device, a memory apparatus or a similar apparatus, for example. The apparatus or the system may include a file server for transmitting the computer program to the receiver, for example.

In some embodiments, a programmable logic device (for example a field-programmable gate array, an FPGA) may be used for performing some or all of the functionalities of the methods described herein. In some embodiments, a field-programmable gate array may cooperate with a microprocessor to perform any of the methods described herein. Generally, the methods are performed, in some embodiments, by any hardware apparatus. Said hardware apparatus may be any universally applicable hardware such as a computer processor (CPU), or may be a hardware specific to the method, such as an ASIC.

While this invention has been described in terms of several embodiments, there are alterations, permutations, and equivalents which fall within the scope of this invention. It should also be noted that there are many alternative ways of implementing the methods and compositions of the present invention. It is therefore intended that the following appended claims be interpreted as including all such alterations, permutations and equivalents as fall within the true spirit and scope of the present invention.

1. An apparatus comprising
a data model, said data model comprising three or more nodes, one or more of the three or more nodes of the data model having an ID assigned to it, each of said one or more nodes being unambiguously distinguishable from the other nodes of the data model by its ID, at least two of the nodes of the data model each comprising one or more attributes, each of said attributes being able to adopt a value stored within the data model, each node of said at least two nodes having a path indication assigned to it, the path indication comprising the respective node to which said path indication is assigned and at least one further of the three or more nodes of the data model, and the path indication of each node of said at least two nodes differing from the ID of the respective node,
a controller comprising a writing function for each attribute of each one of the three or more nodes of the data model which comprises attributes, and the value of the attribute being changeable by means of the writing function, and
a synchronizer,
the synchronizer being configured to receive an update notification designating one of the nodes of the data model, said update notification further designating an attribute of said node, and the update notification indicating how the value of this attribute is to be updated, the update notification designating the node by means of the ID of the node, and
the controller being configured to update the value of this attribute of this node as a function of the update notification by means of the writing function of this attribute,
the apparatus further comprising an interface configured to receive information about changes of the data model which add one or more attributes to one of the nodes of the data model,
the apparatus being configured to generate a writing function for each of said added one or more attributes by means of code generation, the value of the attribute being changeable by means of this writing function, this writing function being configured to inform the synchronizer and/or a view when the value of the attribute changes.

2. The apparatus as claimed in claim 1,
each of the nodes of the data model having an ID assigned to it, and
each of the nodes of the data model being unambiguously distinguishable from the other nodes of the data model by its ID.

3. The apparatus as claimed in claim 1, wherein the controller comprises a reading function for each attribute of each one of the three or more nodes of the data model which comprises attributes, the value of the attribute being readable by means of the reading function.

4. The apparatus as claimed in claim 1, the ID of each of the three or more nodes of the data model being a number or a string or a hash value.

5. The apparatus as claimed in claim 1, wherein the three or more nodes of the data model comprise a graph-shaped structure, so that each node of the data model is immediately followed by at least one of the nodes of the data model within the graph-shaped structure and/or is immediately preceded by one of the nodes of the data model within the graph-shaped structure, at least one of the nodes of the data model being immediately followed by two nodes of the data model within the graph-shaped structure.

6. The apparatus as claimed in claim 1,
the apparatus further comprising an interface configured to receive information about changes of the data model which add one or more attributes to one of the nodes of the data model,
the apparatus being configured to generate a writing function for each of said added one or more attributes, the value of the attribute being changeable by means of the writing function, the writing function being configured to record changes of the value of the attribute over time for later reproduction or undoing.

7. The apparatus as claimed in claim 1, the apparatus being configured to provide the reading function and the writing function for each of the attributes of each one of the nodes of the data model which comprises attributes by means of a web application, so that said reading function and said writing function can be used by means of the web application.

8. The apparatus as claimed in claim 7, wherein the web application is implemented in JavaScript and/or HTML.

9. The apparatus as claimed in claim 1, the apparatus being configured to install, upon a user input, change monitoring for one of the attributes of one of the nodes of the data model.

10. The apparatus as claimed in claim 9, the apparatus being configured to output an alert when a value of one of the attributes for which change monitoring is installed changes.

11. The apparatus as claimed in claim 1, the apparatus being configured to record a change that is made to an attribute of one of the nodes of the data model.

12. A server,
the server being an apparatus as claimed in claim 1,
the server being configured to receive (a) registration(s) from one or more clients,
the server being configured to transmit information about the data model to the one or more clients upon their registrations, said information about the data model comprising the values of the attributes of all of the nodes or of two or more of the nodes of the data model which comprise attributes, and the information about the data model further indicating, for each node of the data model or for the at least two nodes of the data model, which of the nodes of the data model immediately follow said node and/or which nodes of the data model immediately precede said node.

13. The server as claimed in claim 12,
the server being configured to receive (a) registration(s) from one or more clients,
the synchronizer of the server being configured to receive a message from one of the clients which indicates that a value of an attribute of a node of the data model has changed, and
the synchronizer of the server being configured to notify, upon the message of said client, the other two or more clients that have registered with the server of the fact that a value of an attribute of a node of the data model has changed.

14. The server as claimed in claim 12, the server being configured to send a message to a device in a wireless or wired manner, said message notifying the device of the fact that an attribute of one of the nodes of the data model has changed.

15. The server as claimed in claim 14, the server being configured to send the message to the device in a wireless manner.

16. The server as claimed in claim 14, wherein the device is a Renderer for generating one or more loudspeaker signals.

17. The server as claimed in claim 12, the server being configured to receive from the client information about the data model of the client, said information about the data model of the client comprising the values of the attributes of all of the nodes or of two or more of the nodes of the data model of the client which comprise attributes, and the information about the data model of the client further indicating, for each node of the data model of the client or for the at least two nodes of the data model of the client, which of the nodes of the data model of the client immediately follow said node and/or which nodes of the data model of the client immediately precede said node.

18. The server as claimed in claim 12, the server being configured to transmit to the one or more clients, upon their registrations, the IDs of two or more of the nodes of the data model of the server.

19. A client,
the client being an apparatus comprising
a data model, said data model comprising three or more nodes, one or more of the three or more nodes of the data model having an ID assigned to it, each of said one or more nodes being unambiguously distinguishable from the other nodes of the data model by its ID, at least two of the nodes of the data model each comprising one or more attributes, each of said attributes being able to adopt a value stored within the data model, each node of said at least two nodes having a path indication assigned to it, the path indication comprising the respective node to which said path indication is assigned and at least one further of the three or more nodes of the data model, and the path indication of each node of said at least two nodes differing from the ID of the respective node,
a controller comprising a writing function for each attribute of each one of the three or more nodes of the data model which comprises attributes, and the value of the attribute being changeable by means of the writing function, and
a synchronizer,
the synchronizer being configured to receive an update notification designating one of the nodes of the data model, said update notification further designating an attribute of said node, and the update notification indicating how the value of this attribute is to be updated, the update notification designating the node by means of the ID of the node, and
the controller being configured to update the value of this attribute of this node as a function of the update notification by means of the writing function of this attribute,
the apparatus further comprising an interface configured to receive information about changes of the data model which add one or more attributes to one of the nodes of the data model,
the apparatus being configured to generate a writing function for each of said added one or more attributes by means of code generation, the value of the attribute being changeable by means of this writing function, this writing function being configured to inform the synchronizer and/or a view when the value of the attribute changes,
the client being configured to register with a server as claimed in claim 12,
the client being configured to receive, upon registration with the server, information about the data model of the server, said information about the data model of the server comprising the values of the attributes of all of the nodes or of two or more of the nodes of the data model of the server which comprise attributes, and the information about the data model of the server further indicating, for each node of the data model or for the two or more nodes of the data model of the server, which of the nodes of the data model of the server immediately follow said node and/or which nodes of the data model of the server immediately precede said node, and
the client being configured to update its data model as a function of the information about the data model of the server.

20. The client as claimed in claim 19, the client being configured to transmit to the server information about the data model of the client, said information about the data model of the client comprising the values of the attributes of all of the nodes or of two or more of the nodes of the data model of the client which comprise attributes, and the information about the data model of the client further indicating, for each node of the data model of the client or for the at least two nodes of the data model of the client, which of the nodes of the data model of the client immediately follow said node and/or which nodes of the data model of the client immediately precede said node.

21. The client as claimed in claim 19, the client being configured to run in a web browser.

22. The client as claimed in claim 19, the client being configured to transmit to the server the IDs of two or more of the nodes of the data model of the client.

23. A system comprising
a server,
the server being an apparatus as claimed in claim 1,
the server being configured to receive (a) registration(s) from one or more clients,
the server being configured to transmit information about the data model to the one or more clients upon their registrations, said information about the data model comprising the values of the attributes of all of the nodes or of two or more of the nodes of the data model which comprise attributes, and the information about the data model further indicating, for each node of the data model or for the at least two nodes of the data model, which of the nodes of the data model immediately follow said node and/or which nodes of the data model immediately precede said node, and
a client as claimed in claim 19,
the client being configured to send an update notification to the server,
the synchronizer of the server being configured to receive the update notification which designates one of the nodes of the data model of the server, which further designates an attribute of said node and which indicates how the value of this attribute is to be updated, and
the controller of the server being configured to update the value of this attribute of this node as a function of the update notification if the update notification designates the ID of the node.

24. A method comprising
receiving an update notification designating a node of a data model by means of an ID of the node, said update notification further designating an attribute of said node, and said update notification indicating how a value of this attribute is to be updated, said data model comprising three or more nodes, one or more of the three or more nodes of the data model having an ID assigned to it, each of said one or more nodes being unambiguously distinguishable from the other nodes of the data model by its ID, at least two of the nodes of the data model each comprising one or more attributes, each of said attributes being able to adopt a value stored within the data model, each node of said at least two nodes having a path indication assigned to it, the path indication comprising the respective node to which said path indication is assigned and at least one further of the three or more nodes of the data model, and the path indication of each node of said at least two nodes differing from the ID of the respective node, and
updating the value of the attribute designated in the update notification by means of the writing function of this attribute as a function of the update notification,
receiving, by means of an interface, information about changes of the data model which add one or more attributes to one of the nodes of the data model, and
generating a writing function for each of said added one or more attributes by means of code generation, the value of the attribute being changeable by means of this writing function, this writing function being configured to inform the synchronizer and/or a view when the value of the attribute changes.

25. A non-transitory digital storage medium having a computer program stored thereon to perform the method comprising
receiving an update notification designating a node of a data model by means of an ID of the node, said update notification further designating an attribute of said node, and said update notification indicating how a value of this attribute is to be updated, said data model comprising three or more nodes, one or more of the three or more nodes of the data model having an ID assigned to it, each of said one or more nodes being unambiguously distinguishable from the other nodes of the data model by its ID, at least two of the nodes of the data model each comprising one or more attributes, each of said attributes being able to adopt a value stored within the data model, each node of said at least two nodes having a path indication assigned to it, the path indication comprising the respective node to which said path indication is assigned and at least one further of the three or more nodes of the data model, and the path indication of each node of said at least two nodes differing from the ID of the respective node, and
updating the value of the attribute designated in the update notification by means of the writing function of this attribute as a function of the update notification,
receiving, by means of an interface, information about changes of the data model which add one or more attributes to one of the nodes of the data model, and
generating a writing function for each of said added one or more attributes by means of code generation, the value of the attribute being changeable by means of this writing function, this writing function being configured to inform the synchronizer and/or a view when the value of the attribute changes,
when said computer program is run by a computer.
